(19) United States
(12) Patent Application Publication
(10) Pub. No.: US 2010/0070876 A1
(43) Pub. Date: Mar. 18, 2010

(54) Self-Replicating Rich Media Interface

(75) Inventors: Sanjay Jain, New York, NY (US); Gregory Rogers, New York, NY (US)

Correspondence Address: J. Andrew Lowes;Haynes and Boone, LLP, Suite 700, 2323 Victory Ave., Dallas, TX, 75219, US

(73) Assignee: PICTELA, INC., New York, NY (US)

(21) Appl. No.: 12/561,902

(22) Filed: Sep. 17, 2009

Related U.S. Application Data
(60) Provisional application No. 61/097,911, filed on Sep. 18, 2008.
(60) Provisional application No. 61/152,630, filed on Feb. 13, 2009.

(51) Int. Cl. G06F 3/00

(52) U.S. Cl. 715/748

(57) ABSTRACT

A rich media interface allowing a user to consume a variety of media, such as images, audio recordings, video recordings, and texts. The user's interactions with the media may be reported to a server. Through the rich media interface, the user may create a new copy of the rich media interface. The new copy of the rich media interface may be functionally equivalent to the copied rich media interface. The new copy may also report a user's interactions with the media. The reports received from both rich media interfaces may be distinguishable through the use of identifiers associated with each of the rich media interfaces.

This application claims the benefit of U.S. Provisional Application No. 61/097,911 filed Sep. 18, 2008, and U.S. Provisional Application No. 61/152,630 filed Feb. 13, 2009, both of which are hereby incorporated by reference.

### BACKGROUND

As consumers migrate to a more Internet-centric lifestyle, it becomes increasingly important for companies to promote their brands online. Previous online branding systems have often relied on paid placement, for example, banner advertisements on websites. These marketing devices are sometimes viewed by consumers as intrusive. There remains a need for brands to reach the public and potential consumers.

### SUMMARY

According to one aspect, an apparatus includes a tangible computer-readable medium. The medium stores a unique identifier that identifies a set of instructions that when executed by a computer cause the computer to display a media asset to a user. The instructions also cause the computer to report information on the user's interaction with the media asset to a data aggregation computer. The reported information includes the unique identifier. The instructions further cause the computer to respond to a user request by transforming an existing tangible computer-readable medium into a functionally equivalent copy of the apparatus that contains a different unique identifier.

In another aspect, the transforming step includes requesting the different unique identifier from the data aggregation computer and creating a web page that includes an instruction to incorporate the set of instructions.

In yet another aspect, the media asset is an image, a sound recording, a video recording, or a text.

In still a further aspect, the instructions cause the computer to receive information from a server and to save the information in a token on the computer. The information is then provided to the server.

In another aspect, the functionally equivalent copy of the apparatus uses a different execution environment. The functionally equivalent copy of the apparatus may be capable of executing on the computer without interacting with the server.

According to one aspect, there is provided a method of tracking the distribution of a multimedia branding campaign comprising that includes creating a rich media interface object accessible through a first instance identified by a first identifier. The rich media interface object is adapted to self-replicate by causing the creation of a second identifier that identifies a second instance of the rich media interface object. The method also includes storing the rich media interface object and the first identifier on a nonvolatile storage medium. Information is received on the self-replication activities of the rich media interface object, and a report is generated to illustrate the self-replication activities.

In one aspect, the report comprises a visual depiction of a plurality of parent-child relationships among the rich media interface objects.

In another aspect, the visual depiction shows how the parent-child relationships arose over time.

In yet another aspect, the method also includes creating a branding campaign and receiving media assets associated with the branding campaign. Information is received on the end-user interaction with the media assets. Generating a report includes generating a summary of the information on end-user interaction with the media assets.

According to another aspect, a method is provided for promoting a brand through a self-replicating rich media interface. The method includes receiving a plurality of media assets, wherein at least some of the media assets are associated with a campaign to promote a brand of products, services or both. The media assets are stored in a data store. A first identifier having a value is generated and associated with a first rich media interface adapted to access a set or subset of media assets. The method includes writing the value of the first identifier to a nonvolatile storage medium and providing a link to the first rich media interface. The link includes the first identifier. A request to access the first rich media interface is received, and the request also includes the first identifier. A selected media asset is then presented to a user. A request to create a second rich media interface adapted to access the set of media assets is received, and the request includes the first identifier. A second identifier is generated with a value different from the value of the first identifier. The second identifier is associated with the second rich media interface and with the first identifier. The method further includes providing a link to the second rich media interface that includes the second identifier.

In another aspect, the method further includes associating an embedding location with the first identifier. Providing access to the first rich media interface includes comparing a referral location included in the request to access a rich media interface with the embedding location. If the referral location matches the embedding location, access is provided to the first rich media interface. If not, an alternate response is provided. The alternate response may be an error message.

In yet another aspect, the request to create a second rich media interface is received from an instance of the first rich media interface executing on a computer.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Furthermore, all features may not be shown in all drawings for simplicity.

FIG. 1 illustrates a screen shot showing a web browser with one embodiment of a rich media interface displayed in the web browser.

FIG. 2 illustrates a view of one embodiment of a rich media interface.

FIGS. 3a & 3b illustrate views of other embodiments of a rich media interface.

FIG. 4 illustrates an example network architecture.

FIG. 5 illustrates an example of a sharing process for a rich media interface.

FIG. 6 illustrates a copy process for a rich media interface.

FIG. 7 illustrates an exemplary system for performing the copy process of FIG. 6.

FIGS. 8-10 illustrate exemplary table layouts that may be used to store information associated with a rich media interface.

FIG. 11 illustrates a process for creating an original rich media interface.

FIG. 12 illustrates an example system that may be used in performing the process of FIG. 11.

FIG. 13 illustrates an example report.

FIG. 14 illustrates an example sharing process for a rich media interface.

FIG. 15 illustrates an example interface for receiving a user's selection of various options and selections relating to the process of FIG. 14.

FIGS. 16-17 illustrate example contribution reports.

FIG. 18 illustrates an example report.

FIG. 19 illustrates an example messaging sequence for providing a rich media interface to a requester.

FIGS. 20-23 illustrate exemplary decision trees for a rich media interface.

### DETAILED DESCRIPTION

The present disclosure relates generally to providing self-replicating rich media objects and methods of utilizing the same. It is understood that the following disclosure provides many different embodiments, or examples, for implementing different features of the invention. Specific examples of components and arrangements are described below to simplify the present disclosure. These are, of course, merely examples and are not intended to be limiting.

This disclosure presents new technology using branding resources that provide functional, rich-media end-user experiences and are useful, for example, in marketing. A rich media interface can include a variety of media and non-media features, for example:

an image gallery, with thumbnails & caption

an image display,

a video gallery,

a video display, with thumbnails & caption

displayable text information,

non-displayed metadata information, and

a self-publishing interface for multiple blog or social media platforms.

A rich media interface object can come in a variety of sizes and aspect ratios and may be sized according to its content. A rich media interface object can also temporarily increase its size to provide an enhanced media experience, for example by going to a full-screen mode. In full-screen mode, the rich media interface object maintains its full functionality within a full-screen environment. A rich media interface object may also be created with a variety of aspect ratios and sizes.

Rich media interface objects may be used in an earned media branding campaign. An “earned media” branding campaign involves distributing marketing or branding materials to publishers who are not compensated for displaying the materials. For example, an Internet blogger may embed a rich media interface object into his or her blog, but the blogger may not be paid by anyone to do so. Instead, the blogger embeds the rich media interface object because of the blogger's own desire or motivation to publish the media assets available through the rich media interface object. Another example of an “earned media” campaign is a viral marketing campaign in which a link to a video is distributed through social networks, including online social networks such as Facebook or MySpace. By way of contrast, a “paid media” marketing is one where a publisher is paid to display the ad. Many forms of traditional online marketing, including banner ads on websites and blogs, are often, but not always, paid media.

Creating and Editing Rich Media Interface Objects

New rich media interface objects can be created through an automated process. A media asset provider can provide images, videos, text, downloads, hyperlinks, and other information to be used in a rich media interface object. During this media ingestion process, the provided media assets can be transformed, resized, or transcoded and may be stored in a variety of formats or sizes. Selected media assets can then be compiled into a new rich media interface object, and a link to the new rich media interface object is provided.

The creation process includes:
identifying media assets that must be included in copies of the rich media interface;
identifying media assets that a user may later choose to include or exclude from the rich media interface; and/or
providing additional text and meta data, such as captions, titles, hyperlinks, etc.

Rich media interface objects and their associated media resources are distributed to an end-user's web browser from a centralized server or servers, thus allowing a media asset provider the opportunity to edit the rich media interface object and have those edits be immediately effective across the web. Additionally, the media asset provider has the opportunity to add or remove content from rich media interface objects.

A rich media interface object can be established to protect the incorporated media assets so that they are not immediately accessible to an end-user. The rich media interface object's interface can limit the range of actions possible for the end-user, for example, preventing the end-user from extracting the image and video data for uninhibited use. These features can inhibit the creation of unauthorized copies and derivative works based on the media assets incorporated into the rich media interface object. Thus, the rich media interface object allows a media asset provider to distribute a wide variety of media assets (such as images, videos, text, and sound) and to allow end-users to further distribute those assets in a controlled and controllable manner.

Embedding Rich Media Interface Objects in a Web Page

In one aspect, a rich media interface object is incorporated into a web page or other document. The code to embed the rich media interface object includes a unique identification code that allows usage metrics to be gathered for the rich media interface object. The unique identifier can presents itself as a hash value that is passed to a web or media server that uses this hash value to deliver the media assets for the appropriate campaign and to also know what web page had incorporated the rich media interface object.

Syndicating Rich Media Interface Objects

In another aspect, each rich media interface object includes functionality that allows a user to share the rich media interface object. Sharing a rich media interface object may create a new rich media interface object that has its own unique identification code. If the new rich media interface object has a different identification code, usage metrics for it can be tracked separately from other rich media interface objects, including other rich media interface objects that present the same content. The identification codes can be traced from one rich media interface object to a distributed version of the rich media interface object, thus providing the data necessary to trace the lineage of each rich media interface object.

Depending on the amount of freedom granted by the original rich media interface object creator (e.g., the media asset provider), a user may choose to create a copy of the rich media interface object that includes less than all of the media content included in the copied rich media interface object. For example, a user may choose to include only the images and to remove the videos. Or the user may choose to include only a subset of images. Or the user may choose to include only a subset of texts. Of course, the initial creator may turn off this feature and require that every copy of the rich media interface object include the content decided on by the creator.

In a further aspect, the rich media interface object is created so that it will impose limits on the number of copies of itself that can be made, or the functionality available. Thus, the media asset provider can opt to limit the functionality available, either to end-users or to bloggers wishing to incorporate the rich media interface object on their websites, at various numerical or generational milestones. An example use of this feature is a rich media interface object that, in its first generation, is entirely open in allowing a copier to choose what media elements to include in the child rich media interface object. Following that first copy, however, a copier has no ability to change the included media elements. Thus, first tier bloggers have open access, but later copiers (who are copying from these bloggers and not from the original rich media interface object) do not have those choices available.

One-Click Publishing of Rich Media Interface Objects

Another feature of rich media interface objects is that they may include a one-click publishing capability. With a single click, a user can cause a rich media interface object to copy itself onto the user's blog, or any other destination where another use could view the rich media interface object. The rich media interface object creates a copy of itself as described above and creates a new blog posting on the user's blog. In the posting, the rich media interface object places the code necessary to embed the new copy of itself. The blogger may choose to edit the blog posting to include personal comments for the blog readers. The rich media interface object on the blogger's blog includes all of the same media assets and functionality as the one that created it, unless the media asset provider or blogger have chosen otherwise.

Readers of the blogger's blog may use the copied rich media interface object on the blog to create additional copies on their own blogs, web pages, computers, or mobile devices through the same one-click publishing feature.

Another publishing capability of rich media interface objects is the ability to send an email from within the rich media interface object. The email includes a hyperlink or other information allowing the recipient to view the rich media interface object. For example, the hyperlink may include a universal resource locator (URL) for the web page that incorporates the rich media interface object.

Usage Metric Generation

A rich media interface object may provide a rich interactive interface for end users. In one example, it also tracks an end user's interaction and reports detailed usage metrics back to the media asset provider. This reporting occurs through a data aggregation service that receives individual reports and compiles usage metrics from the reports. These usage metrics can include a variety of measurements, including for example:
Impressions, including unique impressions,
Mouse-over time and position (where on the object the user's mouse is located), and
Images and other media that are viewed, for how long, and at what size.
External links can be tracked. Specifically how many people landed on a publisher site, and how many people were taken off of the publisher site.

Tokens & Unique Impressions

A rich media interface object places a token on each computer where it is displayed (for example, every computer that navigates to a web page that includes the rich media interface object). The token may be a cookie, Flash shared object, file, or other storage space. The token may allow the rich media interface object to report usage metrics that are traceable to an individual user. Combining the unique user identification (stored in the token) with the unique identification code associated with each rich media interface object, a report may be generated on the number of unique impressions not just for each web page with the rich media interface object, but across all web pages with other copies of the rich media interface object. Additionally, it is possible to report any of these metrics for all campaigns associated with a client or brand.

Retargeting

Interfacing with paid media advertising networks also allows the rich media interface object to provide information about an end-user's interests. For example, an end-user who engages in a certain amount of interaction with a rich media interface object may be identified as a potential purchaser of associated products. If the rich media interface object is promoting a car, for example, the end-user's interest in buying a car may be recorded in a token used by an online advertising network. When the end-user navigates to other web pages, including those that do not have any embedded rich media interface objects, the token may be used to select marketing materials targeted to the end-user's known interests.

Conversion Tracking

In another aspect, a tracking object is included on a targeted web page. The targeted web page is a web page to which the rich media interface object is intended to increase traffic. For example, the targeted web page may be a sales page for a product promoted in the rich media interface object. The tracking object interacts with the token place on the user computer by the rich media interface object. The tracking object causes the token to be transmitted to a server, which may be server associated with the targeted web page, a server associated with the rich media interface object, or another server. Thus the rich media interface object's tokens may be used to gather statistical information on purchases or other transactions made by a consumer of products or services promoted through a rich media interface object that the consumer viewed.

Linking to Other Blogs and Websites

A rich media interface object may include one or more links to other websites and blogs where the rich media interface object is embedded. Through these links, an end-user can be taken from one website to other websites that include additional comments and information on the same rich media interface object. As with everything else about a rich media interface object, the media asset provider can exercise control over these links, such as by specifying which destination websites should be listed or specifying that the destination websites should be dynamically determined. For example, the links may be dynamically determined by ranking all of the websites that include the rich media interface object by the number of hits received over a period of time. These features can drive additional traffic to websites and blogs incorporating the rich media interface object and provide a benefit to popular bloggers or other web sites.

Reporting

The new level of detail in the usage metrics provided by rich media interface objects allows for the creation of new kinds of reports for evaluating the effectiveness of a marketing campaign. One new kind of report is a visualization tree showing usage across the web.

The visualization tree shows the relationships between the many instances of a rich media interface object that are used on different web sites. At the root of the tree is the original rich media interface object created by the media asset provider. In one method, the media asset provider discloses the location of the original rich media interface object to a selected group of first-tier distributors, such as marketing agents or publishers. Those first-tier distributors, in turn, use the original rich media interface object to create copies that they include on their of web sites and use to notify additional people (such as targeted bloggers) of the availability of the rich media interface object. Those targeted bloggers then use the first-tier rich media interface object to create additional rich media interface objects for their blogs. This process continues to repeat as bloggers learn of the rich media interface objects and use one of the rich media interface objects to create a copy for their own blogs.

Because the origin of a rich media interface object may be traced back to the original rich media interface object created by the media asset provider, the visualization tree can visually depict the spread of the rich media interface object across the multiple websites or blogs. It is also possible to categorize and rank by conversions, mouseovers, and filter by geographic region.

Other visualization trees can make use of color, object size, scale, shape, or other characteristics to convey additional information. For example, the number of unique impressions generated by a website could be represented by the size of its corresponding leaf. Additionally, the horizontal and vertical axes may be to a certain scale and used to represent information, such as a timeline showing when each rich media interface object was copied from its parent.

Usage metrics from rich media interface objects can be combined with an analysis of the content of the websites incorporating the rich media interface objects. Through a content rating system, usage metrics can be filtered and analyzed according to whether a brand is being discussed positively or negatively one those websites. The brand may be associated with the rich media interface objects, or it may be a competitor's brand. Additionally, a visualization tree may also show the inclusion or exclusion of rich media interface objects on a set of predetermined websites.

Usage metrics gathered by or through rich media interface objects can be integrated into web analytics tools such as Omniture, WebTrends, or another data analysis tool.

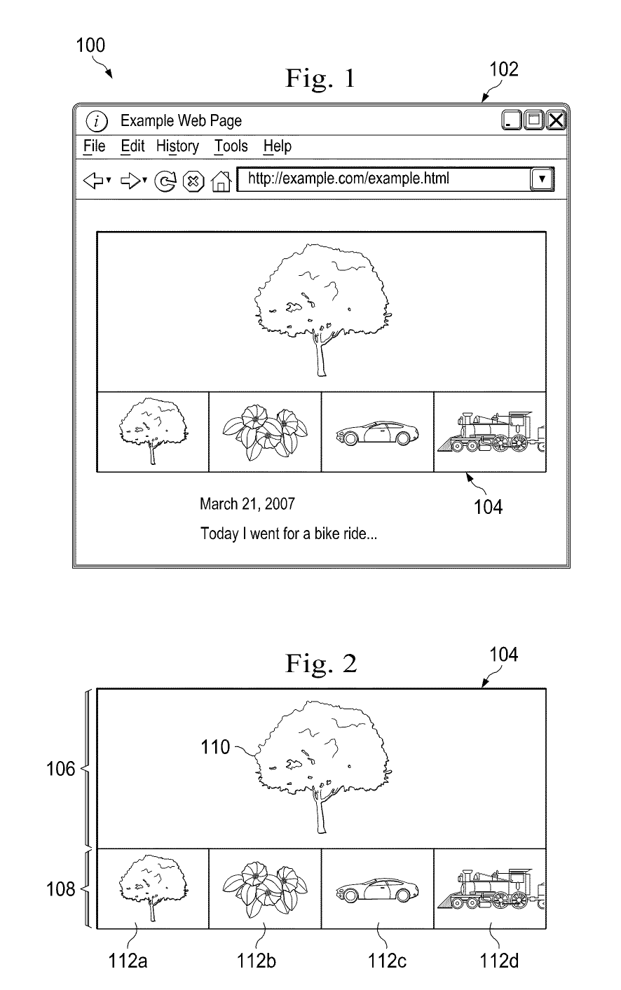

Referring to FIG. 1, illustrated is screen shot showing a web browser image 100 that may be executing on a computer 101. The computer 101 may be connected to a network, such as an intranet or the Internet, through a wired connection, a wireless connection, or both. Active regions on the web browser image 100 may allow the computer 101 to access resources and data available through the network. As illustrated, the web browser 100 has accessed and is displaying a web page 102. The web page 102 may be provided by another computer on the network, or it may be provided by the computer 101 as is displaying it. The web page 102 includes a rich media interface 104. The rich media interface 104 allows a user to access and consume a variety of media, including but not limited to images, video, audio, documents, and text. The media may be in any suitable format, including for example JPEG, GIF, PNG, QuickTime, MPEG, MP3, AAC, TXT, Microsoft Word, Adobe PDF, Microsoft Excel, or Microsoft PowerPoint. The rich media interface 104 may be embedded in the web page 102, for example using an HTML EMBED tag, an HTML IFRAME tag, or a Flash embed tag. The rich media interface 104 may be a program that is downloaded to and executed on the computer. For example, the rich media interface 104 may be programmed using Adobe Flash, Adobe Air, Adobe Flex, Microsoft Silverlight, or any other suitable programming language or environment.

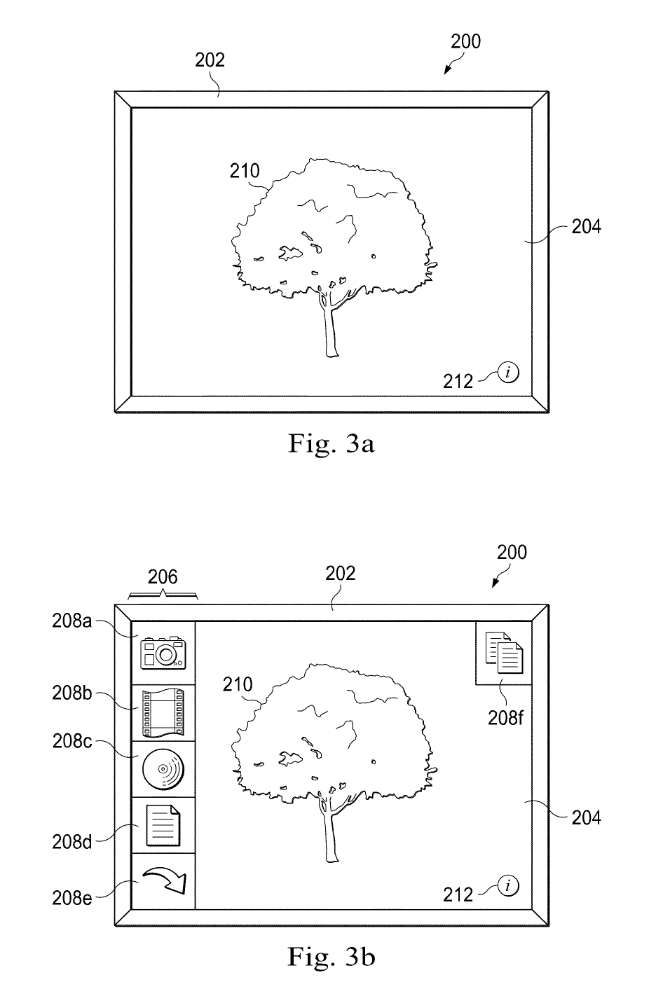

FIG. 2 shows a more detailed view of the rich media interface 104. The rich media interface 104 includes a display area 106 and a menu area 108, which provides a navigation bar. The display area 106 may display a selected media resource, such as the illustrated tree image 110. The menu area 108 displays a selection of menu items 112. A user may select one or more of the menu items 112 to interact with the rich media interface 104. Although FIG. 2 shows four menu items 112, the menu area 108 may also have more or fewer menu items. The user may make a selection by pointing or clicking with a mouse, pointing or gesturing with a finger on a touchscreen, typing on a keyboard, or using any other suitable input device.

The menu items 112 allow the user to select a different media resource to be produced in the display area 106. For example, in one presentation menu item 112a illustrates a tree image, and menu item 112b shows a flower image. The user could select menu item 112b, indicating a desire to view a flower image in the display area 106. In response to a user selection, the rich media interface 104 may change the display area 106 to display the selected media resource. The menu items 112 indicate the availability of any kind of media resource, including photos or other images, videos, slideshows, audio, text, web pages, hyperlinks, or any other media resource. The menu items 112 also allow the user to change the form of the media presentation. For example, a menu item may command the display area 106 to increase or decrease in size, such as by expanding to fill all of the available display space in web browser 100, or to a full-screen mode. Another menu item may start or stop a slideshow mode in which media resources are sequentially presented in a preselected or random order. The slideshow may advance to a next media resource after a period of time, such as 5 seconds, or after receiving a signal, such as an input from the user or a message from a server.

The menu area 108 may be visible to the user at all times, or it may be hidden when not being accessed. For example, if the rich media interface 104 detects that a user is no longer using the menu area 108, such as because a timer has expired since the last user interaction or because of the position of the mouse or other input cursor, the menu area 108 can be hidden. The display area 106 expands to occupy the area of the rich media interface 104 previously occupied by the menu area 108, and in other embodiments the menu area 108 may be changed to a background color, texture, or image.

Alternately, the display area 106 may occupy the entire display area of the rich media interface 104, with the menu area 108 displayed as an overlay over the display area 106. In this case, the menu area 108 may be hidden by showing the display area 106 without any overlay.

In embodiments where the menu area 108 is hidden, the menu area 108 reappears from its hidden state as needed. The rich media interface 104 may detect that the user's cursor, such as a mouse cursor, is located in the vicinity of the rich media interface 104 or the menu area 108, indicating a possible desire to interact with the rich media interface 104. After detecting such an input, the menu area 108 may be displayed again, allowing the user to choose one of the menu items 112.

In other embodiments, the rich media interface 104 may not have any menu area 108, or the menu area 108 may be permanently hidden or inaccessible.

In some embodiments, the rich media interface 104 may also allow a user to access or consume multiple media resources simultaneously. For example, the rich media interface 104 could provide a presentation of a slideshow of images while simultaneously providing an audio output, such as music or speech.

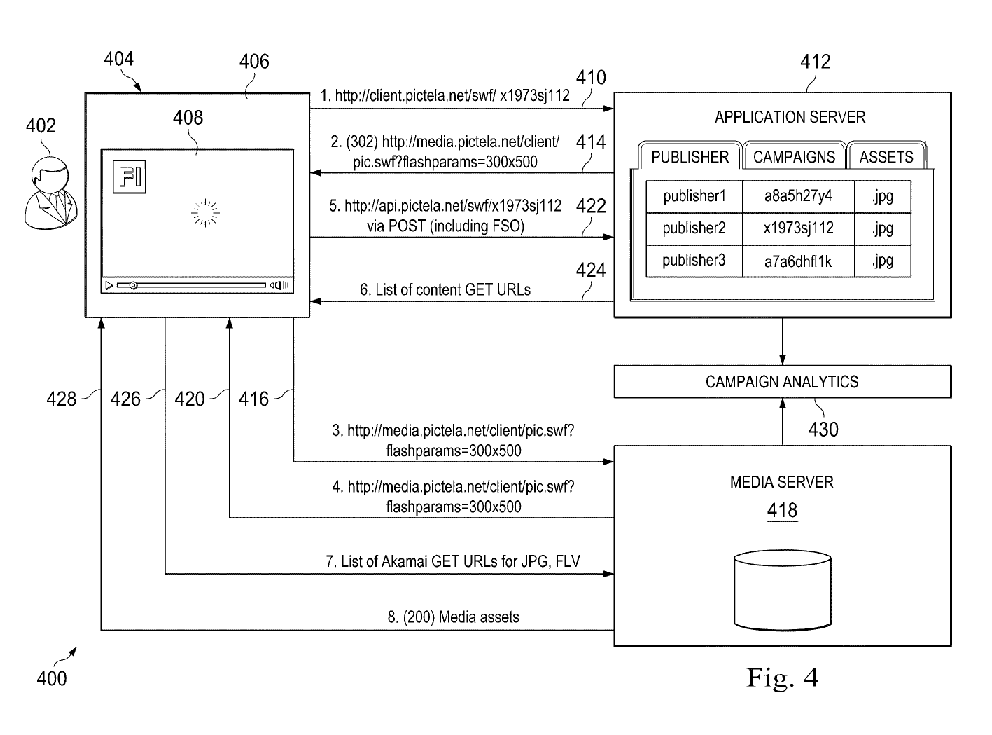

Illustrated in FIG. 3 is another embodiment of a rich media interface 200. The rich media interface 200 includes a border 202 around its perimeter. The border 202 is a line, stroke, overlay, image, or any other suitable border. The border 202 may be partially or completely transparent, and may be symmetrical or unsymmetrical. Within the border 202 is a display area 204, but in other embodiments the border may overlay an outer portion of the display area 204. The display area 204 occupies substantially the entire space within the border 202 because, as illustrated, a menu area is hidden. The display area 204 includes an image 210 of a tree and an information icon 212. If the user selects the information icon 212, the display area 204 may display further information about the image 210. For example, the display area 204 may display supplemental information explaining how or why the image 210 was made, or by whom, or when, or any other suitable information. The information may be displayed as an image, as text, as video, or in any other suitable form. In some embodiments, the information may be produced as audio, or as both audio and visual information. And in still other embodiments, the information may be provided to the user outside the display area 204, such as through a pop-up or by delivery of the information through email, voicemail, postal mail, telephone call, or other delivery service.

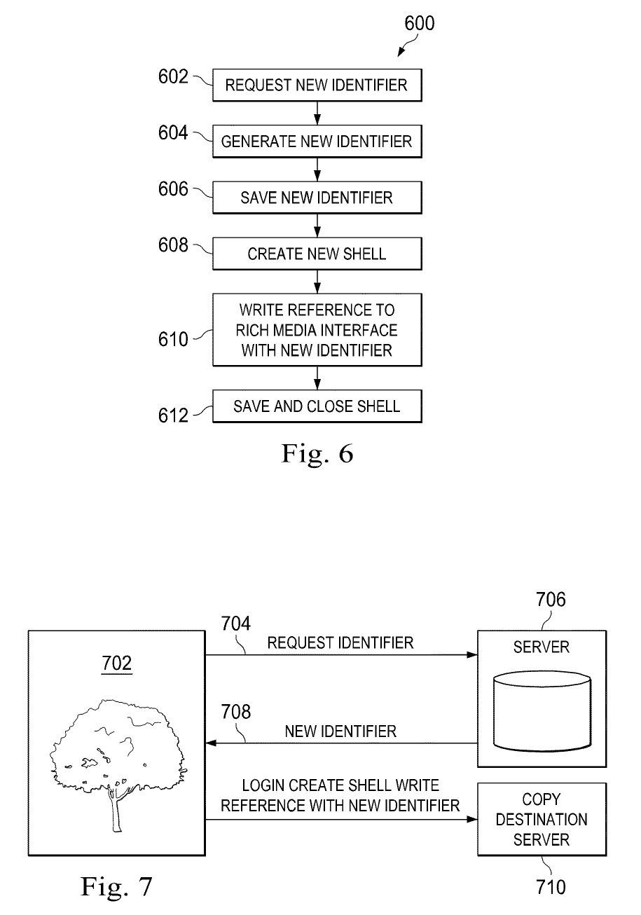

FIG. 3b illustrates the rich media interface 200 with a menu area 206 showing. The menu area 206 includes five menu items. Menu item 208a shows a photo icon. If the user selects menu item 208a, the menu area 206 changes (shown in FIG. 5) to display a group of images available for display. Menu item 208b shows a video icon, and if menu item 208b is selected, the menu area 206 changes to display a group of videos available for display. Menu item 208c shows an audio icon, and if menu item 208c is selected, the menu area 206 changes to display a group of audio resources available for reproduction. Menu item 208d shows a text icon, and if menu item 208d is selected, the menu area 206 changes to display a group of texts available for display. Menu item 208e shows a download icon, and if menu item 208e is selected, the menu area 206 changes to display a group of files that are available for downloading. By downloading a file, the user can view, print, save, or change the file outside the rich media interface 200. A file available for download may be an image, video, document, or other media asset. For example, the rich media interface 200 can facilitate the downloading or saving of a white paper, presentation, or annual report, which may be stored using Portable Document Format (PDF). As another example, the rich media interface 200 can facilitate the downloading or saving of an audio file, such as a WAV, MP3- or AAC-encoded file. The rich media interface 200 can also permit the downloading of additional executable code, such as a program or game. The downloadable content available through the rich media interface 200 may be content that is marketed through the rich media interface 200.

Finally, menu item 208f shows a share icon. The share icon allows the user to create a copy of the rich media interface 200. In response to the user's command, the rich media interface copies itself to another web page, an email, to the user's computer desktop or similar location, or to another device, such as a phone or portable media browser. Thus, the rich media interface is capable of self-replication. In another embodiment, the rich media interface provides an embed code to the user so that the user can manually create add a reference to the new copy of the rich media interface in another web page, an email, or other location.

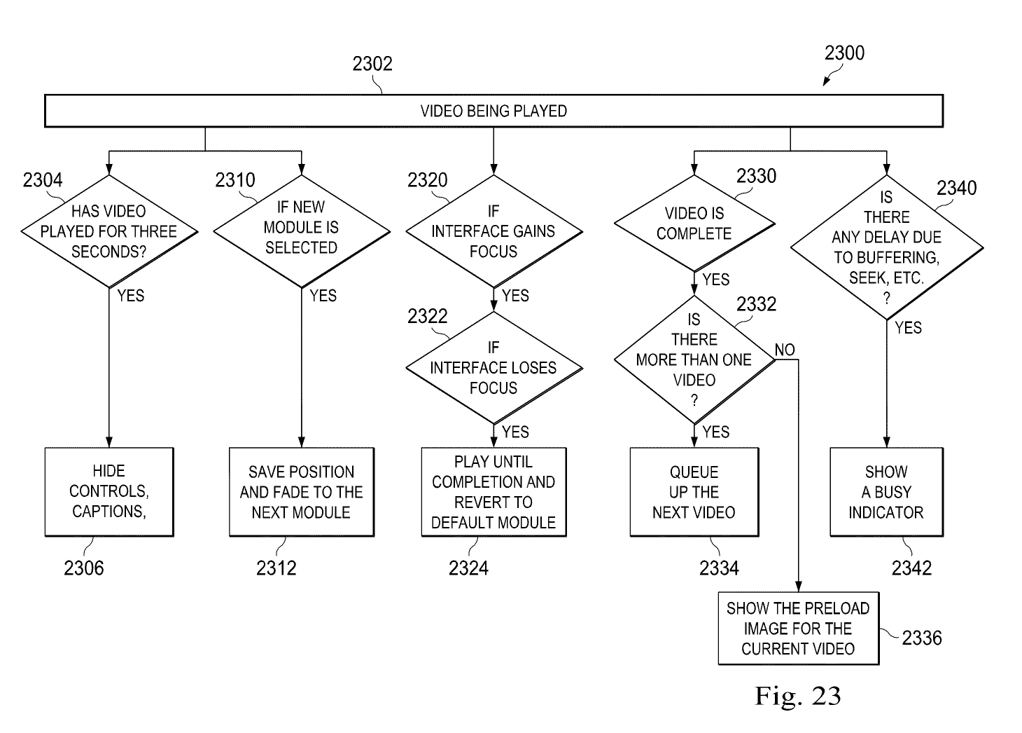

FIGS. 20-23 illustrate exemplary decision trees for a rich media interface, such as the rich media interface 200. In FIG. 20, the decision tree 2000 begins at step 2002 with loading the rich media interface. In step 2006, a determination is made whether the rich media interface's theme, or user interface skin, includes an always-visible navigation bar. If so, then in step 2014 the navigation bar for the theme is displayed.

In step 2004, a determination is made as to whether a user is interacting with the rich media interface, for example, by placing a mouse cursor over the rich media interface. If so, then in step 2010 a determination is made whether the rich media interface's theme, or user interface skin, includes an always-visible navigation bar. If not, then in step 2014 the navigation bar for the theme is displayed.

In step 2012 a determination is made whether an interstitial is defined for the rich media interface. An interstitial is a display that the user must acknowledge before beginning to interact with the rich media interface. The interstitial, when present, may be text, graphic, audio, or any suitable combination of plain or rich media assets. If there is no interstitial, or if the navigation bar is always available, then in step 2014 the appropriate navigation bar for the rich media interface's theme is shown.

If in step 2012 an interstitial is defined, then in step 2016 the interstitial is shown. Then in step 2018, a determination is made whether the user has acknowledged the interstitial, for example, by clicking with the mouse or providing a similar input gesture. When the determination is true, in step 2020 the remainder of the rich media interface is enabled and the user is allowed to interact with it. Then in step 2022, an initial module for the rich media interface is loaded. In some embodiments, the initial module may be loaded earlier, for example, with the rich media interface in step 2002. Thus, the user may be able to see the initial content of the rich media interface sooner. The interstitial may be partially transparent so that the initial content is partially viewable even when the interstitial is shown.

Referring now to FIG. 21, exemplary decision tree 2100 begins in step 2102 when a photo module is activated. The photo module may be activated, for example, in step 2022 of FIG. 20, or it may be activated through the user's interaction with the rich media interface, for example, through the navigation bar. In step 2104, a determination is made whether the rich media interface is being provided as part of an advertisement, for example, as part of a paid media marketing campaign. If not, then in step 2106 an automatic slideshow of images begins.

If in step 2104 the rich media interface is part of an advertisement, then in step 2108 a determination is made whether the rich media interface should automatically play. If so, then in step 2110 a determination is made whether the photo module is loading as part of the loading of a containing web page. If so, then in step 2112 a slideshow presentation of images begins and continues for a predetermined period of time, for example, 15 seconds. If the photo module is not begin loaded as part of the loading of its containing web page, then execution proceeds to step 2106.

While the photo module is loaded, a determination is repeatedly made in step 2114 whether the rich media interface has gained focus, for example, by the user moving a mouse cursor or other input device over the rich media interface. If so, then in step 2116 additional user interface navigation items are displayed, such as a gallery of images and next/previous arrows. Then in step 2118, a determination is made whether the rich media interface has lost focus. If so, then in step 2120 the additional user interface navigation items displayed in step 2116 are removed or hidden, restoring the initial display.

Referring now to FIG. 22, exemplary decision tree 2200 begins in step 2202 when a video module is activated. The video module may be activated, for example, in step 2022 of FIG. 20, or it may be activated through the user's interaction with the rich media interface, for example, through the navigation bar. In step 2204, a determination is made whether the rich media interface is being provided as part of an advertisement, for example, as part of a paid media marketing campaign. If not, then in step 2206, a determination is made whether the video module is loading as part of the loading of a containing web page. If so, then in step 2208 a video is prepared for display by queuing content, and the video is played only after the user clicks on a play button or provides a similar command. If in step 2206 the video module is not loading as part of the loading of a containing web page, then in step 2210 a video is prepared for display and begins playing without waiting for any further user input.

If in step 2204 the rich media interface is part of an advertisement, then in step 2212 a determination is made whether the video module is loading as part of the loading of a containing web page. If so, then in step 2214 a determination is made whether the video module is automatically begin playing a video. If not, then execution continues to step 2208. If a video should begin playing automatically, then execution continues to step 2210.

FIG. 23 illustrates exemplary decision tree 2300 that begins in step 2302 when a video is being played. While the video is being played, several determinations are repeatedly made. In step 2304, a determination is made whether the video has been playing for a predetermined period of time, for example, three seconds. If so, then in step 2306 the navigational interface elements and any caption text are hidden.

In step 2310, a determination is made whether another module has been selected by the user. If so, then in step 2312 the current video playback location is saved, and the selected module is loaded and activated. The other module may be activated by fading the display to transition from the user interface for the video module to the user interface of the other module.

In step 2320, a determination is made whether the rich media interface has gained focus, for example, by the user's mouse cursor or other input device being located over the rich media interface. If so, then in step 2322 a determination is made whether the rich media interface has subsequently lost focus. If so, then in step 2324 the video playback continues to the end of the video, and then the rich media interface's initial module, if other than the video module, is loaded and activated.

In step 2330, a determination is made whether the video playback is complete. If so, then in step 2332 a determination is made whether there is more than one video available. If so, then in step 2334 the next video is queued for display. If there are no additional videos available, then in step 2336 a preload image associated with the single video is displayed.

In step 2340, a determination is made whether the video playback is experiencing a delay because of buffering or seeking to a different playback location. If so, then in step 2342 a busy indicator is shown to inform the user.

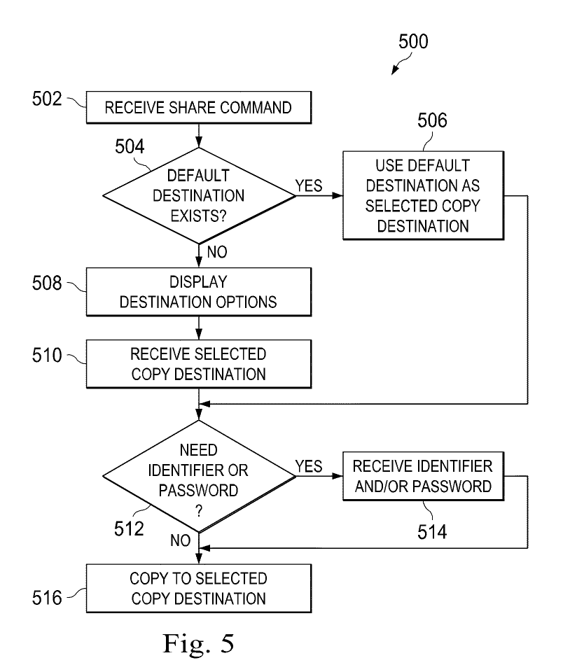

FIG. 4 illustrates an example network architecture 400 for supporting a rich media interface. A user 402 uses a web browser 404, which is any suitable web browser, including but not limited to Microsoft Internet Explorer, Mozilla Firefox, Apple Safari, or Google Chrome. The user 402 uses the web browser 404 to navigate to a web page 406 that includes a rich media interface 408. The rich media interface 408 is embedded in the web page 406 through the use of an EMBED tag that is part of various hypertext markup language (HTML) coding standards, or through any other suitable technique. The EMBED tag provides the web browser 404 with an address for obtaining the code needed to activate or display the rich media interface 408, such as through a uniform resource locator (URL) address. The web browser 404 uses the URL address to send a message 410 to an application server 412. The message 410 is a hypertext transfer protocol (HTTP) GET message or other suitable message for requesting content, and the server 412 is a web server or other suitable server. For example, the server 412 may be a computer or computing grid executing Microsoft Internet Information Server (IIS), Apache web server from the Apache Software Foundation, or other suitable server software. The server 412 may be implemented using hardware, software, or both, and may include one or more computers. In some embodiments, the server 412 is implemented using a cloud computing model that can scaleably adjust to meet demand. For example, the server 412 may be implemented with the EC2 service available from Amazon. With cloud computing, the server 412 may employ a service to control and manage the scaling up and down of the size of the cloud. An example of a cloud management service is the RightScale Platform available from RightScale. The message 410 includes an identifier that informs the server 412 of what content is being requested. The identifier identifies the rich media interface 408 that generated the request, the web page 406 that generated the request message 410, or both. The identifier may uniquely identify the rich media interface 408. In the example of FIG. 4, the identifier of message 410 is “x1973sj112” but in other embodiments the identifier may be different, and may be longer or shorter. The identifier may be associated with a client, for example, a client that owns or that provided a set of media resources that are to be made available to the user 402 through the rich media interface 408. The identifier may be associated with a campaign for the client, such as a marketing or branding campaign. The message 410 may optionally include a media size indicating a desired height and width of the rich media interface 408.

The server 412 responds to the message 410 with response 414. The response 414 is an HTTP REDIRECT response, such as a response with HTTP status code 302. In other embodiments, other redirect responses, including for example status codes 300, 303, and 307 are possible. The response 414 provides a substitute address for the information requested in request 410. The server 412 may use any media size information in the message 410, if provided, to determine a size of a rich media interface. The rich media interface to be provided may be the same size as the desired height and width, or it may be the closest size available, or the closest size available that is at least as large as the size requested, or the closest size available that is no larger than the size requested. In some embodiments, the determination of what size rich media interface to provide may be made by a media server 418. In other embodiments, the size of the rich media interface may be fixed.

The message 410 includes a reference to the web page 406, or to the server that provided web page 406. This reference is used by server 412, in conjunction with the identifier, to verify that the rich media interface 408 has been embedded in an approved web page. For example, if server 412 detects that the web page 406 is on a list of unapproved web pages, then it may provide an alternate response to the web browser 404. For example, rather than provide the redirect message 414, the server 412 provides a “not found” message, such as HTTP status code 404, or an access denied message, such as HTTP status code 401 or 403.

After receiving the response 414, the web browser 404 sends a second request 416 to the address provided in the response 414. The second request 416 is an HTTP GET request and is directed to a media server 418. The media server 418 may be implemented using hardware, software, or both, and may include one or computers. In some embodiments, the media server 418 shares computing resources with the server 412. For example, the media server 418 and the server 412 may both be software that executes on a single computer or a single computer cluster.

The media server 418 responds to the second request 416 by sending the requested data in response message 420. For example, where the rich media interface 408 is provided as an Adobe Flash application, the response message 420 includes a Flash SWF file. In other embodiments, the rich media interface 408 uses other programming technology and the response message 420 contains the appropriate content. The media server 418 may use size information, if provided in the second request 416, to determine which among several available sizes of rich media interface 408 to provide in response message 420.

When the web browser 404 receives the response message 420, the web browser 404 executes the received program. For example, the web browser 404 may start the Adobe Flash plug-in, or another suitable execution environment, to interpret the response message 420. This begins the execution of the rich media interface 408.

The rich media interface 408 sends a message 422 to the server 412 to request a list of media resources. The message 422 is an HTTP GET message or an HTTP POST message. The message 422 includes an identifier, which may be the same identifier previously included in message 410. In some embodiments, the message 422 includes information about the web page 406, such as a URL for accessing the web page 406. The message 422 may also include size information indicating a requested height and width of media content. The server 412 responds to the message 422 with response 424. The response 424 includes a list of URLs for content that will be accessible through the rich media interface 408.

The rich media interface 408 then sends a request 426 for one of the resources included in the list received in response 424. The request 426 is sent to media server 418, but in other embodiments it may be sent to another server. The request 426 is an HTTP GET message. The media server 418 then sends response 428 that includes the requested media resource. The response 428 includes an HTTP OK message. If the media server 418 sends instead another response, such as an error or not-found response, the rich media interface 408 sends a message (not shown) to the server 412 to alert the server 412 to this error condition.

The rich media interface 408 then provides the media resource received in response 428 to user 402. For example, the media resource may be displayed as previously described with respect to FIGS. 1-3. If the user 402 selects to view or play another media resource, the rich media interface 408 sends another request message 428 to the media server 418.

The media server 418, the server 412, or both may report information on the requests received and processed to campaign analytics 430. Campaign analytics may process and summarize the information received and provide reporting capabilities.

Alternately, the rich media interface 408 may execute a script, possibly provided by server 412, media server 418, or another server, that provides instructions on presenting media resources. For example, the instructions can specify that the media resources are to be displayed or otherwise presented to the user 402 in a specified order. In other embodiments, the instructions specify that some or all of the media resources should be presented in a random order or an order determined using fixed criteria.

The rich media interface 408 continues to send requests to the media server 418 until it obtains all of the media resources on the list obtained in response 426. Thus, the rich media interface 408 may load some or all of the media resources listed in the response 424 before the user 402 requests them. By fetching and caching the media resources ahead of time, the rich media interface 408 provides an enjoyable interactive experience for the user 402. For media resources that the rich media interface 408 does not fetch ahead of time, the rich media interface 408 acquires them in a streaming manner if or when they are requested by the user 402. For example, a video is downloaded and played as a streaming media playback, for which the rich media interface 408 does not need to fetch the entire video ahead of time. And because the playback is on the streaming basis, the user 402 does not have to wait while the entire video is downloaded before playback begins.

In other embodiments, the rich media interface 408 may request the media resources as they are requested by user 402.

In some embodiments, some or all of the media resources that are provided through rich media interface 408 are determined dynamically. For example, a URL included in the response 424 can refer to a dynamic feed, such as an really simple syndication (RSS) or Atom feed. The RSS or Atom feed can identify one or more images, texts, or other media resources that change dynamically over time. By incorporating this kind of dynamic feed, the content provided through the rich media interface 408 may be kept current with little or no extra effort. In still other embodiments, dynamic information may be incorporated into the rich media interface 408 from a message posting service, for example a Twitter stream. The message posting service source may be specified by the media asset provider or when copying a rich media interface.

The rich media interface 408 may provide feedback information about how the user 402 interacted with one or more of the media resources. Examples of information that may be provided include how long the user viewed or otherwise consumed the media resource, whether and where the user attempted to interact with the resource (such as by clicking or pointing), which parts of a video or audio resource the user consumed, whether the user activated a full-screen mode, where and for how long the user's cursor was located on the rich media interface 408, or any other information relating to the user's media consumption experience. This feedback information may be provided with a request message 426, or it may be provided through a separate message. The feedback message may be sent to the media server 418, to the server 412, or to another server. The feedback information may be sent periodically, for example based on a timer or on the user 402's actions and requests. Alternately, the information may be sent when the rich media interface 408 closes, such as when the user 402 closes web browser 404 or navigates away from web page 406. Along with the feedback information, the rich media interface 408 may provide the identifier previously provided in messages 410 and 422. This identifier may allow the feedback information to be associated with the web page 406. The user may also feedback directly through the rich media interface 408, for example, by voting for a favorite media asset or rating one or more media assets.

The rich media interface 408 also stores on the computer one or more tokens provided by the server 412, the media server 418, or both. The token may be a cookie, Flash shared object, file, or other storage space. These tokens are used to track the user 402's activities over a period of time. For example, the user 402 may visit the web page 406 multiple times. On the first visit that the user 402 makes to the web page 406, the rich media interface 408 saves a token on the user's computer. When the user 402 makes a subsequent visit to the web page 406, the rich media interface 408 transmits the previously saved token to the server 412, media server 418, or both. The information stored in the token includes an identifier that distinguishes the user 402 from other users that visit the web page 406. By providing the token to the server 412, media server 418, or both, the rich media interface 408 provides information for tracking the number of unique visitors to the web page 406 and/or rich media interface 408.

In another embodiment, the rich media interface 408 saves more than one token on the user 402's computer. For example, the rich media interface 408 may save a token for providing tracking information to a third party, such as an online advertising network, including a paid media advertising network. The rich media interface 408 may also transmit a token to a server other than server 412 and media server 418. For example, the rich media interface 408 can transmit a token associated with an online advertising network to a server associated with that network. In this way, the online advertising network compiles tracking statistics on the popularity of the rich media interface 408. The online advertising network may be operated by an independent third party. Examples of online advertising networks include Right Media, DoubleClick, Atlas DMT, and Eyeblaster.

In still another embodiment, the web page 406 saves one or more tokens instead of, or in addition to, the tokens previously described as being saved by the rich media interface 408.

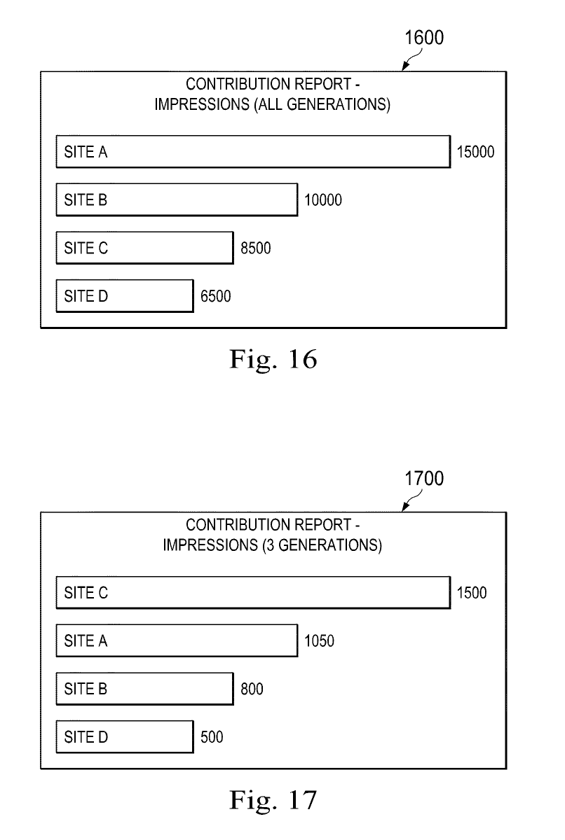

The server 412, media server 418, or both allow for the exporting of various forms of tracking data gathered from messages or reports received from the rich media interface 408. In one embodiment, the data is exported in the form of a report, such as the report described below with respect to FIG. 13. In another embodiment, the data are exported for analysis in a traffic analysis program such as Omniture, WebTrends, or another analytics platform. The data may be exported at any time, including being exported manually, automatically for example based on activity or time triggers, or programmatically. The data may be exported as a database, file, XML datastream, or in any other suitable format.

The server 412, media server 418, or both may use a variety of techniques to ensure that the rich media interface 408 is not embedded in a web page 406 that is undesirable, or to ensure that if the rich media interface 408 is embedded in a web page 406 that is undesirable then the rich media interface 408 is less functional or nonfunctional. One technique is to collect a list of Internet domain names where the rich media interface 408 should not be allowed. This list of “banned” Internet domain names may be gathered, for example, by humans or by an automated web crawler that processes web pages using a fixed or dynamic list of keywords that are associated with undesirable content. The list of banned Internet domain names may also be acquired from a third party. The server 412 may refer to the list of banned Internet domain names when it receives the request message 410, which may include referrer information such as the URL address for the web page 406 that has embedded the rich media interface 408. By analyzing the request message 410, the server 412 may determine whether the web page 406 is within a banned Internet domain name. The server 412 may make this determination when it receives the request message 422 instead of, or in addition to, making a determination after receiving request message 410.

In another embodiment, the server 412 may dynamically evaluate the content of the web page 406 when it receives the request message 410. Based on the analysis of the web page 406, the server 412 may determine whether the web page 406 includes content that is objectionable, either in general, for a campaign associated with the rich media interface 408, or for a client. If the server 412 determines that the web page 406 includes objectionable content or otherwise should not be permitted to embed the rich media interface 408, then the server 412 may provide an alternate response to the request message 410. For example, the server 412 may provide a response indicating that the requested content is not available, or it may provide a response that will generate a blank area where the rich media interface 408 would have otherwise appeared. The blank area may also include a message, such as a message indicating why the rich media interface 408 is not available. The server 412 may dynamically evaluate the content of web page 406 when it receives the request message 422 instead of, or in addition to, doing so after receiving request message 410.

In yet another embodiment, the server 412 may request that another server, such as a server operated by a third party, to evaluate the content of the web page 406. The evaluation may be in real-time, such as being performed before the server 412 provides a response to the request message 410. The evaluation may also be delayed, such that the server 412 initially responds to the request message 410 with the response 414, but if at a later time it is determined that the web page 406 should not be permitted to embed the rich media interface 408, the server 412 will respond to another request with an alternate response as described above.

The server 412 may implement still other techniques for verifying the appropriateness of allowing the web page 406 to embed the rich media interface 408, either in addition to or instead of the above techniques. The server 412 may track the use of the identifier that is included in the request message 410 and may associate that identifier with the web page 406. Then if the code for embedding rich media interface 408 is embedded in a different web page, the server 412 will recognize that a request to load the rich media interface 408 originated from that different web page and not from the web page 406. As is discussed in greater detail below, the rich media interface 408 may provide a mechanism for the user 402 to create a copy of the rich media interface 408 so that the user 402 may incorporate it into a different web page. Performing that process may generate a new identifier that the server 412 may then associate with that different web page, thus allowing the different web page to access and embed an appropriate copy of the rich media interface 408. Thus, the server 412 may ensure that the sharing process incorporated into the rich media interface 408 is used to embed a copy of the rich media interface 408 in a new or different web page, and thereby ensure that statistics gathered through users' interactions with the rich media interface 408 (and potentially other instances created through the sharing process) are accurate.

The server 412, the media server 418, or both may also monitor requests for data to detect if the frequency of requests is excessive or is indicative that a denial-of-service attack is occurring. Appropriate response may be taken, including ignoring some requests that are identified as forming part of the denial-of-service attack.

A variety of alterations may be made to the network architecture set forth in FIG. 4 without detracting from the functionality of the system. For example, the functions performed by server 412 may alternately be performed in whole or in part by the media server 418, and functions performed by the media server 418 may be performed in whole or in part by the server 412. Similarly, the rich media interface 408 may operate outside of the web browser 404, for example, as a stand-alone application or as a desktop widget. Additionally, the rich media interface 408 may execute on or be accessible through a specialized platform, for example, a cell phone or portable media browser.

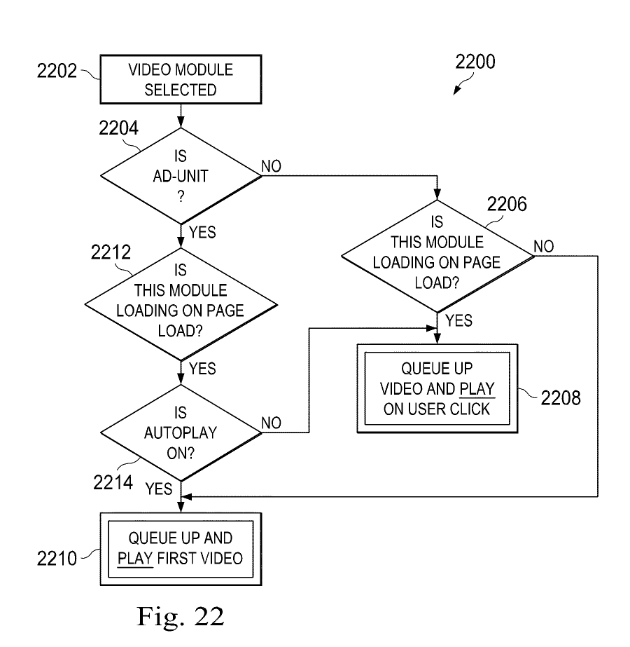

FIG. 19 illustrates an example messaging sequence 1900 for providing a rich media interface to a requester 1902. The requester 1902 may be a web browser, portable rich media device, or other suitable hardware or software requester for accessing the rich media interface. The messaging sequence 1900 begins with a the requester 1902 sending a message 1910 to a content server 1904 requesting a specific rich media interface identified with a unique identifier. The content server 1904 may be a single server, or it may be a grid, cloud, or other network of servers. For example, the content server 1904 may be implemented as a content delivery network. The message 1910 may be implemented, for example, as an HTTP GET message. The unique identifier in the message 1910 serves to uniquely identify an instance of a rich media interface. The content server 1904 returns a response 1912 that redirects the requester 1902 to a bootloader and that provides zero or more parameters for the rich media interface. The parameters may include height, width, and an address to an image to be displayed while the bootloader is downloaded and executed. The content server 1904 may communicate with a application server 1906 in order to obtain data provided in the response 1912. The application server 1906 may be a single server, or it may be implemented as a grid, cloud, or other network of servers. For example, the content server 1904 may cache data to reduce the load on the application server 1906.

The requester 1902 then transmits a message 1914 requesting the bootloader specified in the response 1912. The content server 1904 responds with the requested bootloader. The bootloader is an executable program for loading the remaining executable code and media assets to provide the rich media interface. The bootloader may be a Flash SWF file or any other suitable executable code. The requester 1902 transmits a message 1916 requesting the initial image, if any, identified in the response 1912. The content server 1904 responds with the requested image. The message 1916 may be transmitted and processing asynchronously with other messages and responses, such as the message 1914. The messages 1914 and 1916 may be implemented, for example, as an HTTP GET message.

The requester 1902 then transmits a message 1918 requesting an interface module. The interface module provides executable code providing some or all of the functionality of the rich media interface. The interface module may be, for example, a Flash SWF file. In some embodiments, there may be multiple interface modules. When there are multiple interface modules, they may be distinguished by the type of rich media to be rendered. For example, there may be an image module, a video module, and a rich text module. Or the multiple interface modules may be distinguished from each other by providing access to media assets from different marketers or brands. In this way, a single rich media interface can allow multiple brands to share display space. The content server 1904 responds by providing the requested interface module in message 1920. The content server 1904 may communicate with a application server 1906 in order to obtain data provided in the response 1920.

The requester 1902 transmits a message 1922 to request metadata for media assets to be rendered or made available through the rich media interface. Some embodiments may include multiple messages 1922, for example, there may be one message 1922 for each of several interface modules. The content server 1904 provides a response 1924 including the requested metadata. The metadata includes information about one or more media assets, such as an address for obtaining the media asset. The metadata may be provided using eXtensible Markup Language (XML), and the address may be a URL. The message 1922 and response 1924 may be transmitted and processed asynchronously with respect to other messages and responses.

The requester 1902 transmits a message 1926 to request a media asset, and the content server 1904 provides a response 1928 with the requested media asset. There may be more than one message 1926, for example, when there are multiple media assets identified in the response 1924. The request 1926 and response 1928 may transmitted and processed asynchronously with respect to other messages and responses.

One aspect of the present disclosure is the ability of a user to share a rich media interface, such as the rich media interface 200 or the rich media interface 408. FIG. 5 illustrates an example sharing process 500 for a rich media interface. The process 500 begins with step 502 receiving a share command. The share command may come from the user selecting menu item, for example menu item 208f of the rich media interface 200, or another similar menu item. Next in step 504, where it is determined whether a default destination exists. For example, the rich media interface 200 may inspect the computer to determine whether the user has previously stored a preferred destination for the rich media interface 200. For example, the user may have configured the computer to use the user's web log, or blog, page as a default destination. If such a default destination exists, the process continues to step 506 in which the default destination is selected as the copy destination.

If there is no default destination, then in step 508 a menu of possible copy destinations is displayed to the user. The list of possible destinations may include options such as web logs and personal web pages. Examples of web logs and personal web pages include WordPress, Blogger, Facebook, Hi-5, Bebo, A Small World, Twitter, and MySpace, but these examples are not intended as limiting or exhaustive. The list of possible destinations may also include a location on the user's computer, such as the Desktop, or on an attached device, whether physically or logically attached, such as a phone, music player, mp3 player, video player, or other media player. The list of possible destinations may also include devices that are not currently attached but which are known to the computer, such as a portable device that periodically synchronizes with the computer, for example, a portable media player. The list of possible destinations may also include a custom option that will provide the user with the ability to manually copy the rich media interface 200, for example, by providing a snippet of HTML code for embedding a copy of the rich media interface 200 into any web page. The list of possible copy destinations displayed in step 508 may include some, or all of these possible copy destinations.

The process 500 then continues to step 510 where a selected copy destination is received. The selected copy destination may be received through any appropriate user interface device, such as a mouse, keyboard, touchpad, touchscreen, button, microphone, or other input device.

Next in step 512, it is determined whether the selected copy destination—whether selected by the user in step 510 or selected by default in step 506—requires a log-in ID, password, both, or any other security or authorization information. For example, in copying to a user's blog, the user's username and password may be needed. Another example is that copying to the user's desktop or mobile phone may require a security check, such as a password. If some form of authorization information is needed in order to perform the requested copy, that information is obtained in step 514. The authorization information may be obtained from the user or from any other appropriate source. For example, the user's username and password for a blog service may be saved to the computer, allowing the user to make changes to the user's blog without manually providing the username and password each time. Thus, the rich media interface 200 may use the user's already-stored username and password.

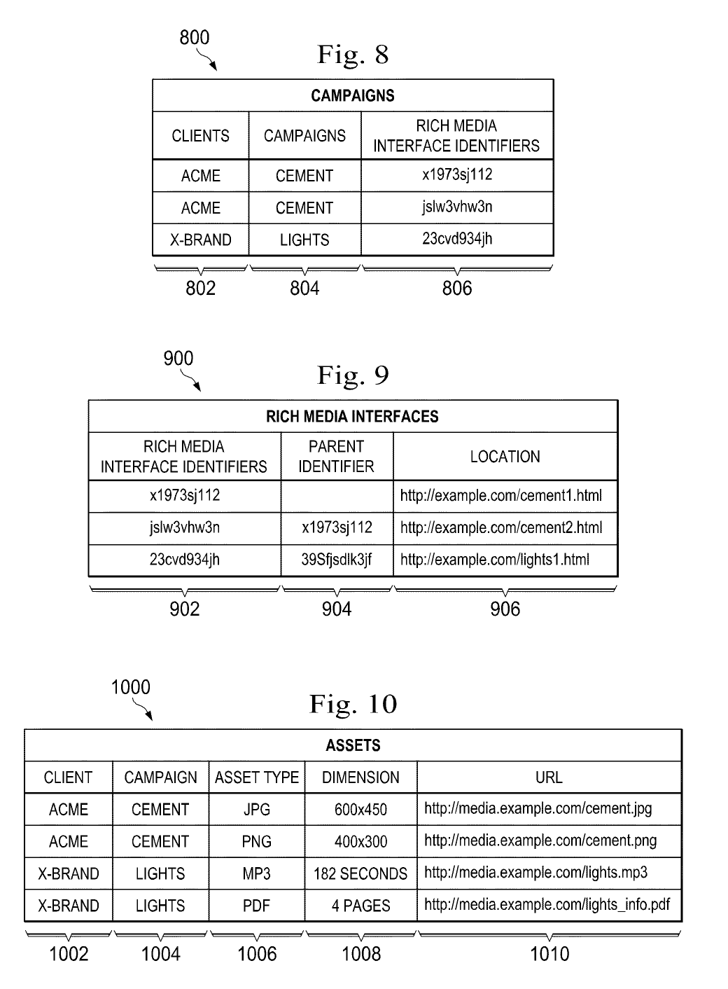

Finally, in step 516 the rich media interface 200 is copied to the selected copy destination. This copying step is disclosed in greater detail in FIG. 6 discussed below.

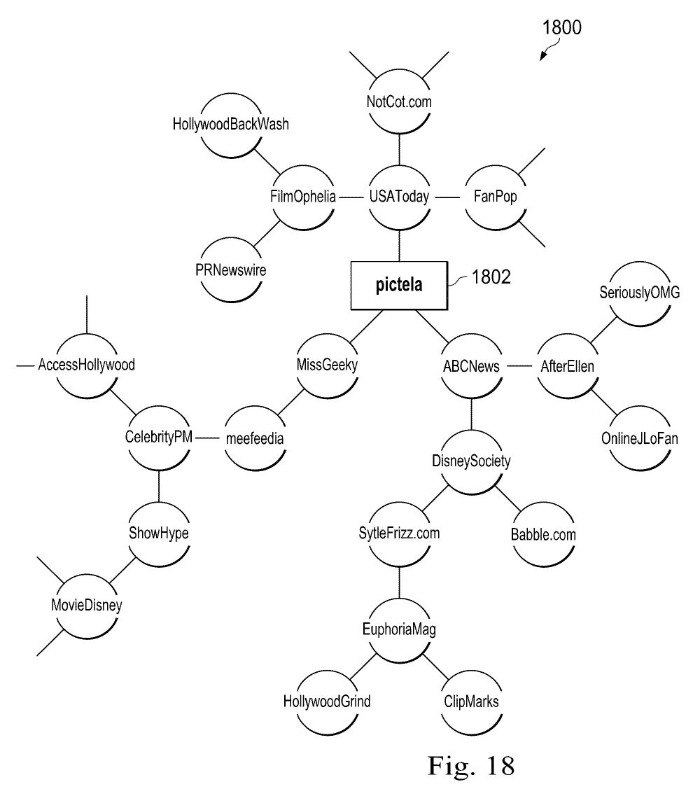

FIG. 14 illustrates a different sharing process 1400 for a rich media interface. The sharing process 1400 begins with step 1402. In step 1404, one or more share types are displayed to a user. Similar to the discussion of a destination above for step 508 of process 500, a share type may be a location on the Internet, a location on the user's local computer or network, a location on a phone or other portable or detachable device, or any other suitable location.

In step 1406, an indication is received specifying a share type desired. Similar to the discussion of a destination above for step 508 of process 500, a share type may be a location on the Internet, a location on the user's local computer or network, a location on a phone or other portable or detachable device, or any other suitable location.

In optional step 1407, share options for the selected share type are displayed. The options may a size selection or aspect ratio selection, a selection of assets, and a user interface skin selection. Some embodiments may include more or fewer options.

In optional step 1408, an indication is received of a specified size or aspect ratio for the new rich media interface copy. The size or aspect ratio or both may be specified using a list of allowable or available sizes previously selected by the rich media asset provider. In other embodiments, the size may be freely selectable, or it may be freely selectable within a range of sizes. The aspect ratio may be freely selectable or it may be fixed.

In optional step 1410, a selection of assets is received. In this way, the user can customize or personalize the new rich media interface copy. In some embodiments, the user may be able to reorder the assets, for example, the user may select an image or other media asset to be the first displayed asset in the new rich media interface copy. In some embodiments, the user may select which media assets will be included in the new rich media interface copy. For example, the user may choose a subset of images or videos to be included. The selected media assets may be chosen from those available in the rich media interface being copied, or they may be chosen from a larger set of assets made available by the media asset provider. When multiple media asset providers have provided the available media assets, such as when information from multiple brands is included in a single rich media interface, then the selected media assets may be chosen from those provided by one, some, or all of the media asset providers. For example, the selected media assets may be the subset of media assets provided by just one media asset provider. In still other embodiments, the user may be able to supplement the available assets, such as by uploading a new image or video. For example, the user may provide or specify a customized branding element, such as a corporate logo or other image. In another example, the user may provide an image or other media asset that will become part of the available catalog of assets. The provided image or other media asset may, for example, be a submission for a contest or other marketing campaign.

It is contemplated that a rich media interface copy may share some, all, or none of its media assets with the rich media interface from which it was copied. For example, a rich media interface may describe a particular model of car from a car maker. A user could create a copy of the rich media interface and tailor that copy, using media assets provided by the car maker or another source, to describe a different model of car. Owing to differences between the two cars, the rich media interface copy might not include any of the media assets from the copied rich media interface.

In optional step 1412, an indication of a user interface skin is received. The user interface skin provides information on the visual appearance of the user interface of the original rich media interface. For example, the user interface skin may provide information about the size, shape, form, color, texture, visibility, and location of buttons, links, or other elements of the user interface. The user interface skin may be chosen from a selection of available user interface skins dictated by the media asset provider, or it may be created by the user or loaded from another source. For example, the user may specify a skin to match the user interface components associated with the share type specified in step 1406.

Finally in step 1414, a new rich media interface copy is created using the specified options and selections. This step is shown in greater detail in FIG. 6. In other embodiments, step 1414 made be accomplished using a sharing connector service. For example, the new rich media interface copy may be created at the location identified by the selected share type using the application programming interface provided by the Gigya service.

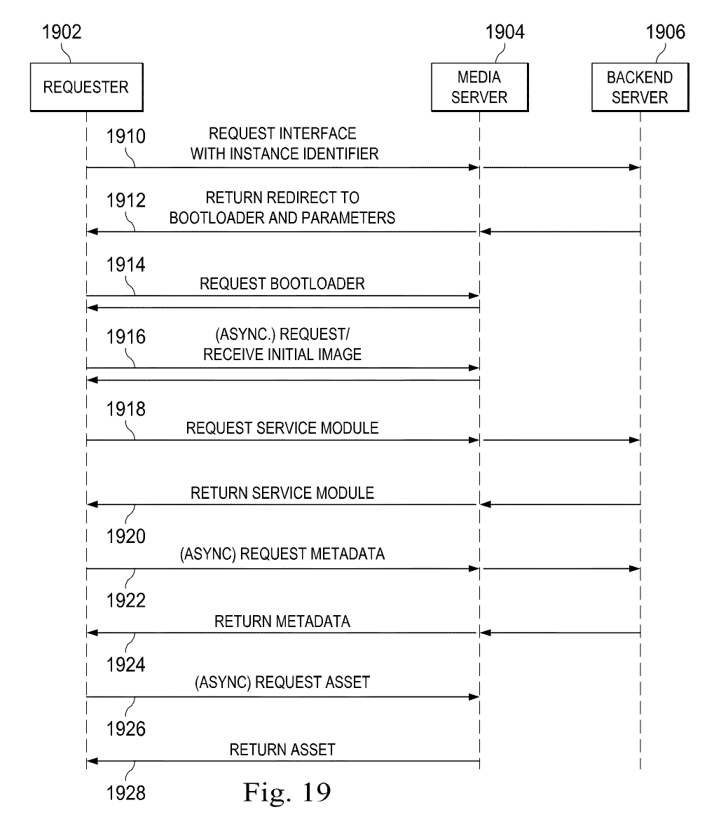

FIG. 15 illustrates an example interface 1500 for receiving a user's selection of various options and selections relating to the process 1400 of FIG. 14. The interface 1500 includes a size selection 1502 with options allowing the user to choose from among several pre-selected sizes. A component sharing selection 1504 allows the user to choose, using media asset categories, which media assets to include in the new rich media interface copy. The user can also make a first image selection 1506 to specify a media asset that will be the first displayed. A theme selection 1508 allows the user to choose a user interface skin. The user can also specify a destination selection 1510. It is understood that other embodiments may have more, fewer, or different selections for creating a new rich media interface copy.

FIG. 6 illustrates a copy process 600 for copying a rich media interface. The process begins in step 602 with an existing rich media interface requesting a new identifier to be used to identify a new copy of the rich media interface. In step 604, a new identifier is generated. The new identifier may be generated from a random number generator, or using a hash function, or any other suitable technique. The new identifier may be unique. Next in step 606, the new identifier is saved to a data store. The data store may be a file system, database, or other form of data storage. The data store may be stored in RAM, on a magnetic medium such as a hard drive or floppy disk or tape, on a optical medium such as a compact disc or DVD or Blu-ray, on a flash RAM, on punch cards, or any other computer readable medium. Additional information may be saved along with the new identifier, such as information indicating where the new copy of the rich media interface will be used or embedded. For example, the data store may associate with the new identifier the URL of the copy destination. The data store may also store the new identifier along with an indication of the content that the rich media interface should present.

Then in step 608, a new shell is created at the copy destination for containing the new copy of the rich media interface. The shell is created by writing to an existing computer readable medium, thus transforming the computer readable medium to contain new information relating to the shell. The computer readable medium may be RAM, a magnetic medium such as a hard drive or floppy disk or tape, an optical medium such as a compact disc or DVD or Blu-ray, a flash RAM, a punch card, or any other computer readable medium. The new shell may vary depending on the location or type of the copy destination. For example, if the copy destination is a blog, the shell may be a blog posting. If the copy destination is a web site, the shell may be a web page. If the copy destination is a computer desktop or device, such as a mobile phone, the shell may be a file, program, or widget. Depending on the copy destination, creating the new shell may require using security or authentication information, such as a login username, password or both. For example, creating a new blog posting may require logging into a blog hosting server using the user's username and password. This login information may be the login information that was gathered in step 514 of the process 500.

The process 600 then continues in step 610 where a reference to a rich media interface with the new identifier is written to the new shell. Writing to the new shell further transforms the computer readable medium where the new shell is stored. For example, if the shell is a web page or a blog posting, then HTML or other suitable code may be written including an EMBED or similar tag with the URL of the rich media interface with the new identifier. If the destination is a computer desktop or attached device, a similar reference to the rich media interface with the new identifier may be written. For example, executable instructions may be written to a file that, when executed, will produce the rich media interface. The media content to be displayed or rendered by the rich media interface may also be written, such that it may be accessed in an offline manner without requiring network access to a media or content server. The media content may be written in an encrypted form to prevent unauthorized duplication or use of the media content.

The reference to the rich media interface may use a different programming technology than the rich media interface that is being copied. For example, a rich media interface embedded on a web page may be programmed using Adobe Flash and may be used to create a copy of the rich media interface on a user's desktop that uses Adobe Air. Using Adobe Air, an Adobe Flash unit can execute outside of a web browser environment, such as on a desktop.

Finally in step 612, the shell is saved and closed. The process 600 then ends. Optionally, the shell may be left open instead and presented to the user for further modification. For example, if the copy destination is a blog, the shell blog posting may be presented to the user so that the user may add comments or other writing to the blog posting.

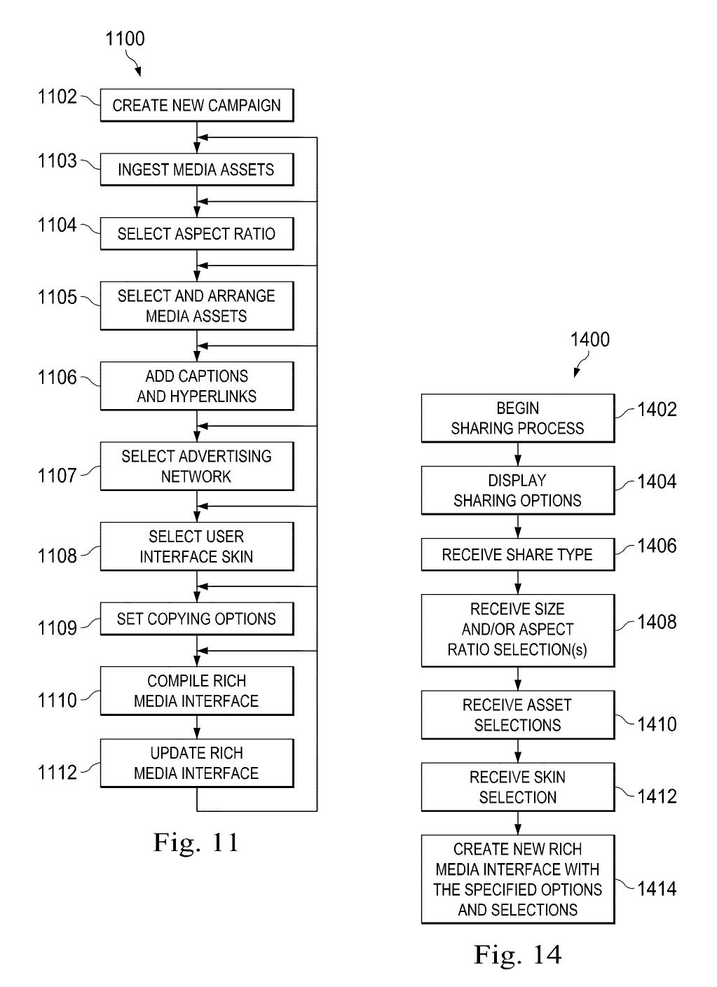

Turning now to FIG. 7, illustrated is an exemplary system 700 for performing a copy process such as the copy process 600. The system 700 includes a rich media interface 702 that sends a request for a new identifier 704 to a server 706. The server 706 responds to the request with a new identifier 708. The request 704 may include the identifier of the rich media interface 702, which allows the server 706 to associate the new identifier 708 as having been created as a child of the identifier of rich media interface 702. The request 704 may also include a copy destination indicating where the new rich media interface associated with the new identifier 708 is being created. The server 706 may save this information also, allowing the server 706 (or another server) to later detect whether requests associated with the new identifier 708 are coming from a different location, indicating that an unauthorized copy of a rich media interface may have been made or attempted.

The rich media interface 702 may then log in to a server 710 associated with the copy destination. For example, the server 710 may be a web server hosting a user's blog. After the server 710 acknowledges the user's username and password, the rich media interface 702 may create a new shell, such as a web page or blog posting. The rich media interface 702 may then write in that shell the HTML or other code necessary to embed a new rich media interface using the new identifier 708.

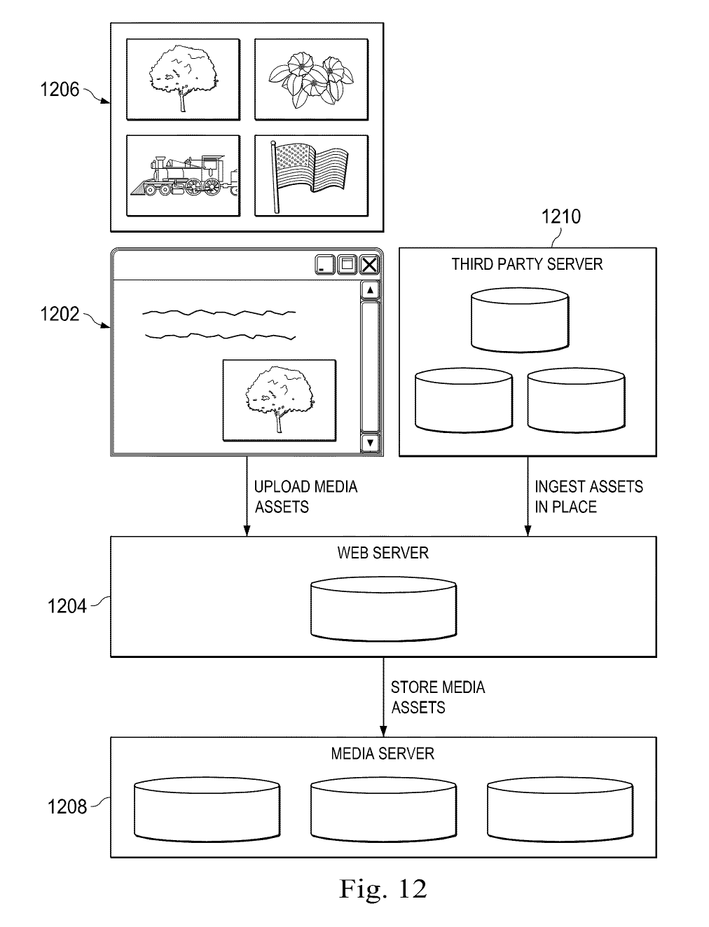

Referring now to FIGS. 8-10, illustrated are exemplary table layouts that may be used to store information associated with a rich media interface. The tables may be part of a relational database stored or accessed by a server such as the server 710. It is understood that other database designs may also be used, including more or fewer tables, including more or fewer columns, and including columns with different names or in a different order. It is also possible to use non-relational database designs.

FIG. 8 shows a CAMPAIGNS table 800 that includes three columns. A first column 802 identifies clients. A second column 804 identifies campaigns. A client may have one or more campaigns. A third column 806 identifies rich media interface instances that are associated with a client and a campaign. A campaign may have one or more rich media interface instances. The rich media interface instances are preferably identified by identifiers that are unique across all clients and campaigns.

FIG. 9 shows a RICH MEDIA INTERFACES table 900 that includes three columns. A first column 902 identifies rich media interface instances. The identifiers in column 902 may correspond to identifiers in column 806 of the CAMPAIGNS table 800. A second column 904 identifies parent rich media interface instances. For one record in the RICH MEDIA INTERFACES table 900, the identifier in column 904 may identify another entry in the RICH MEDIA INTERFACES table 900. For example, the second record with identifier “jslw3vhw3n” indicates that it was created using the rich media interface with identifier “x1973sj112.” For records that do not have a parent (for example, the first instance of a rich media interface made through the ingestion process explained below), the column 904 may be blank, null, or may have the same value as column 902. Thus, the RICH MEDIA INTERFACES table 900 indicates that the rich media interface with identifier “x1973sj112” does not have a parent.

A third column 906 identifies a publisher or location of the rich media interface instance. The value in column 906 may provide a URL or similar locator for the page, document, or device into which the rich media interface instance is embedded.

FIG. 10 shows an ASSETS table 1000 that includes five columns. A first column 1002 identifies clients. A second column 1004 identifies campaigns. A third column 1006 identifies an asset type. The asset type may indicate whether the asset is an image, a video, an audio file, a document, text, or any other kind of asset. The asset type may further indicate the format of the asset, for example, to distinguish between a JPEG image and a PNG image. A fourth column 1008 identifies one or more dimensions for the asset. For example, an image or video asset may be available in multiple sizes. Similarly, an audio or video asset may be available in multiple lengths, such as a trailer length and a full length. A fifth column 1010 identifies a location for the asset, such as a URL.

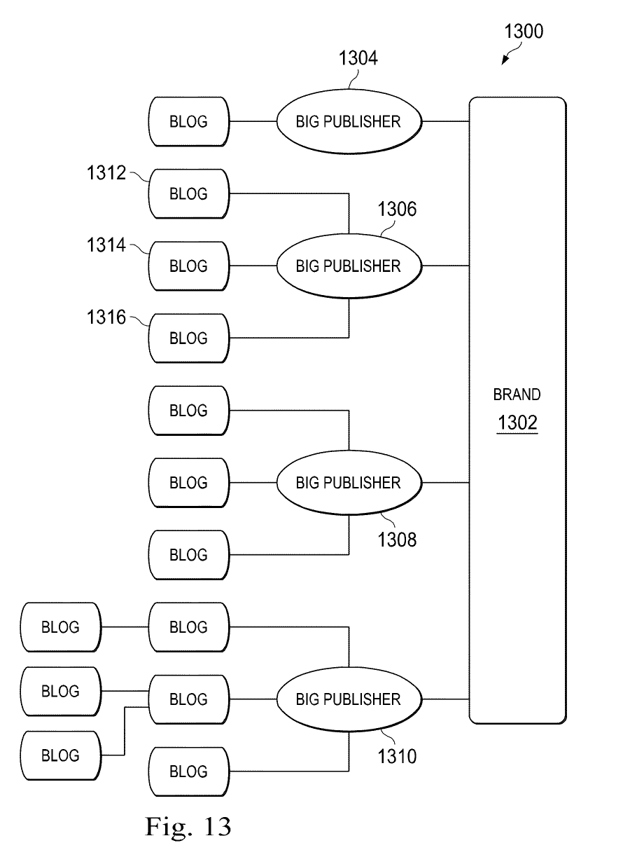

FIG. 11 illustrates a process 1100 for creating an original rich media interface. That is, the process 1100 can create a new rich media interface that does not have a parent rich media interface. The process 1100 begins in step 1102 with creating a new campaign. The campaign may be for any purpose, including for example to promote a new or existing brand, product, or service. The campaign may also be to raise awareness, for example, for a political, social, environmental, or other cause. Next in step 1103, one or more media assets are ingested and associated with the new campaign. These media assets may be images, videos, audio recordings, texts, documents, games, or any other form of media asset. During the ingestion step, a database may gather information about the media assets, including possibly metadata information about the assets. Examples of such information include file size, dimensions, length, bit depth, resolution, format, and encoding type. The media assets may be provided by making reference to an existing rich media interface, by uploading files, by providing a URL address such as an RSS or Atom feed, or by any other appropriate manner. The provided media assets may be saved or transferred to a server, such as a media server, or they may be left in a current location. The ingestion step may also include transforming the provided media assets, such as by resizing or transcoding, and multiple copies of the transformed media assets may be saved. For example, the ingestion step may involve resizing, cropping, or letterboxing some or all of the provided image assets to one or more fixed sizes. For example, an image that is provided with an initial size of 2880×1920 pixels may be resized and saved as two images, with one image having a size of 600×400 pixels and the other image having a size of 320×240 pixels. As another example, a provided image with an initial size of 2880×1920 pixels may be resized and cropped or letterboxed to 533×400 pixels. Preferably the image is resized and, if necessary cropped or letterboxed (or a suitable combination of cropping and letterboxing), to form images of multiple sizes including for example 600×450, 600x400, 400x267, 400x300, 300x400, 300x225, 300×250, and 300×600. Corresponding transformations may be applied to video media assets.

As mentioned above, when a media asset is provided with an aspect ratio that differs from the aspect ratio of a selected size, a user may elect to using cropping, letterboxing, or some combination of both to fit an image or video asset into the selected size. When cropping is used in whole or in part to change the aspect ratio of a media asset, the cropping procedure may be manual or automatic. With automatic cropping, a media ingestion server may automatically crop the asset dimensions to preserve the central portion of the asset. Alternatively, intelligent cropping may be used to select which parts of an asset should be discarded by cropping. Intelligent cropping may use an analysis of the asset, such as determining the areas of a photograph that are brighter or in focus or include people's faces, to select which part of an asset is more important and thus what other part should be cropped when necessary. In some embodiments, intelligent cropping may determine that no part of the image should be cropped, and that instead the image should letterboxed to change its aspect ratio.

Thumbnail assets may also be generated for the ingested media assets. For example, a frame from a video may be used as a still image and resized to a thumbnail size. Alternately, some or all of a video may be resized to a thumbnail size, thus generating a thumbnail video. The thumbnail assets may be used to provide previews of the media assets. An example of a thumbnail size is 50×50 pixels.

Next in step 1104, an aspect ratio and size are selected for the original rich media interface. Any aspect ratio may be chosen, for example, 2:3, 3:4, or 5:7. In choosing an aspect ratio, an orientation may also be selected, such as landscape or portrait. Thus, aspect ratios such as 3:2, 4:3, and 7:5 are also contemplated. Any appropriate size may be selected, such as 600×400 pixels, 600×450 pixels, 400×267 pixels, 400×300 pixels, 300×400, or 330×225 pixels. Alternately, multiple sizes or aspect ratios may be selected such that a specific size, aspect ratio, or both may be chosen at a later time. For example, a selection of sizes and/or aspect ratios may be available during a sharing process like that previously described with respect to FIG. 5. Additional sizes may also be chosen for presentation in a full-screen mode. Example full-screen sizes include 1200×784 pixels and 1200×800 pixels.

Next in step 1105, media assets are selected and arranged to create a user interface for the original rich media interface. For example, the media assets may be arranged in a hierarchical menu, in a thumbnail gallery, or in a free-form storybook fashion. Captions, titles, descriptions, or other text may be added to media assets. Additional metadata to be incorporated into the original rich media interface may also be provided. For example, tag words may be added that are intended to assist search engines in indexing the contents of the original rich media interface. These tag words may be incorporated into the content of the original rich media interface, or they may be made part of the embedding code that is used to incorporate the original rich media interface into a web page or other document, or both. Also in step 1105, any media assets that may be made available for download are arranged.

Then in step 1106, captions, hyperlink destinations or both are provided for some or all of the assets. The captions may be plain text or rich text, and they may be provided in multiple languages. The hyperlinks may provide a link to another rich media asset, a website, a file, or any other suitable link destinations. The hyperlinks may also provide a trackable, click-through destination.

Then in step 1107, an advertising network is selected. Example advertising networks are provided by Glam Media and Undertone Networks, but other advertising networks are also contemplated. Selecting an advertising network may initiate the inclusion into the original rich media interface one or more software components to improve or facilitate communication with the selected advertising network.

Then in step 1108, a user interface skin is selected. The user interface skin provides information on the visual appearance of the user interface of the original rich media interface. For example, the user interface skin may provide information about the size, shape, form, color, texture, visibility, and location of buttons, links, or other elements of the user interface. Alternately, a new user interface skin may be created for the original rich media interface. The user interface skin may use images, sounds, text, or other media assets that were ingested in step 1103.

In step 1109, copying options are determined. The copying options may allow or restrict a user's ability to create a copy of the original rich media interface. For example, a user may be allowed to create a copy of the original rich media interface only to certain restricted destinations, such as only to online destinations and not to a computer desktop or other local device. The copying options may allow copies of the original rich media interface to be placed on destinations through a sharing connector that can facilitate placing a copy of the original rich media interface on a user's choice from a variety of destinations. An example of a sharing connector is the Gigya service application programming interface. The user may also be allowed or denied the ability to determine which assets will be available in a copy of the original rich media interface. For example, the user may be allowed to create a copy of the original rich media interface that includes only its images and not any of the other media assets. The user may also be allowed to rearrange the media assets available through the rich media interface, for example, to change the order of images in a slide show or to change the default media asset that displays when the rich media interface initially loads. Alternately, the user may be denied all possibility of changing the content of the rich media interface but still be allowed to make copies of it. It is understood that these are merely examples of possible copying options and that any combination of options may be available.

In step 1110, the original rich media interface is compiled and a reference to the location of the original rich media interface is provided. This reference may be, for example, a URL. By loading the URL, for example, through embedding the URL in a web page and subsequently visiting that web page, the original rich media interface can be viewed and used. As previously described, new copies of the original rich media interface can be made using its own interface.

In optional step 1112, the original rich media interface may be updated. For example, media assets may be added or removed or rearranged, the aspect ratio or size may be changed, or the user interface skin may be changed. Media assets that are added or changed may be made part of the original rich media interface, or they may simply be available in a catalog of media assets available when a user creates a copy of the original rich media interface or one of its descendants. When media assets changes are made, an indication may optionally be made on some or all associated rich media interface instances, and an email, instant message, SMS text message or other notification may optionally be sent to individuals who have created copies of the rich media interface.

The media asset changes may be made effective immediately, or they may be saved for future activation. Alternately, multiple versions of the rich media interface may be saved, and a switch between or among them may be scheduled for a future date or time. For example, if the original rich media interface is for providing investor information to corporate shareholders, the original rich media interface may be created as a pre-announcement version and a post-announcement version. The post-announcement version may include additional media assets, such as an annual report or letter to investors. On a release date for the investor information, such as an earnings release date, the original rich media interface may be switched, either manually or automatically, to the post-announcement version. The release date may further include a release time that identifies a particular time during the day when the release is made available. There may also be multiple releases so that the available content changes multiple times, whether on one date or over multiple dates.

Because the contents of a rich media interface are loaded dynamically, as described previously with respect to FIG. 4, the updates made in step 1112 may be made effective globally for all copies of the original rich media interface. Thus a provider of media assets may retain control over the display and use of the provided media assets, including the control to add or remove or substitute media assets at any time. In this way, the content available through the rich media interfaces can be modified without requiring the consent, cooperation, or participation of the individuals or entities that maintain the websites and/or other locations that include a copy of the rich media interface.

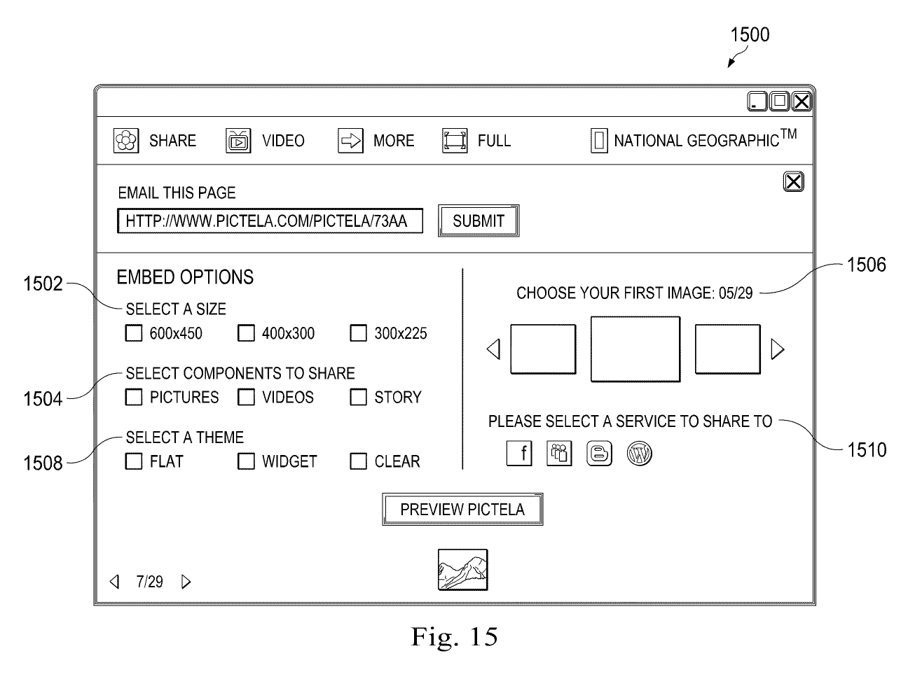

FIG. 12 illustrates an example system 1200 that may be used in performing the process 1100. The system 1200 includes a web browser 1202 for accessing web pages and other services provided by a web server 1204. The web server 1204 receives and ingests media assets 1206 uploaded through the web browser 1202. The web server 1204 may store the ingested media assets on a media server 1208. The web browser 1202 may also direct the web server 1204 to ingest media assets stored on third party server 1210, and the web browser 1202 may ingest these media assets in place, that is, without storing copies of the media assets on the media server 1208. In other embodiments, the storage capability of the media server 1208 may be incorporated into the web server 1204.

The web server 1204 may provide web pages to the web browser 1202 to allow the ingested media assets to be arranged and provided with captions, menus, or other interface components, and the relevant options for the original rich media interface may be set. The web server 1204 may then compile the original rich media interface and generate a new web page that embeds the new original rich media interface. This new web page may be provided to the web browser 1202 so that the original rich media interface can be distributed using the built-in duplication capability.

In another embodiment, the web server 1204 may provide an exposed programming interface, such as an application programming interface (API) that is publicly accessible, to allow for the ingestion of media assets and the creation or modification of an original rich media interface. Thus, the creation or modification of an original rich media interface may be incorporated using software-as-a-service concepts into other branding or marketing tools or platforms.

The detailed usage and tracking statistics that are available through the rich media interfaces described above allow for new and more powerful analytical reports. An example report 1300 is illustrated in FIG. 13, which shows the tree-like parent-child relationships between various instances of a rich media interface. At the root of the tree structure is an original rich media interface instance 1302, which may have been created using a process such as that described with respect to FIGS. 11-12. From the original rich media interface instance 1302, four child copies 1304, 1306, 1308, and 1310 were made. From the child copy 1306, three additional child copies 1312, 1314, and 1316 where made. Thus, the report 1300 shows how various instances of a rich media interface spread across different sites. The report provides information on how the “viral spreading” of a rich media interface occurs.

The report 1300 may use the size, color, or position of the objects representing individual rich media interface instances to convey additional information. For example, the size of each object may indicate the number of total impressions or unique impressions provided by each corresponding instance. A horizontal or vertical axis may represent a timeline, with each object's location along that timeline indicating the time when the instance was copied from its parent instance. The color of each object may indicate the result of a content analysis of the web page or blog or other location that has embedded the corresponding rich media interface instance. For example, a red object may indicate that the content analysis suggests a negative treatment of the media assets available in through the rich media interface, while a green object may indicate a positive treatment. Some or all of these features may be combined into one report, providing a fast analytical tool for evaluating the breadth and success of a campaign.

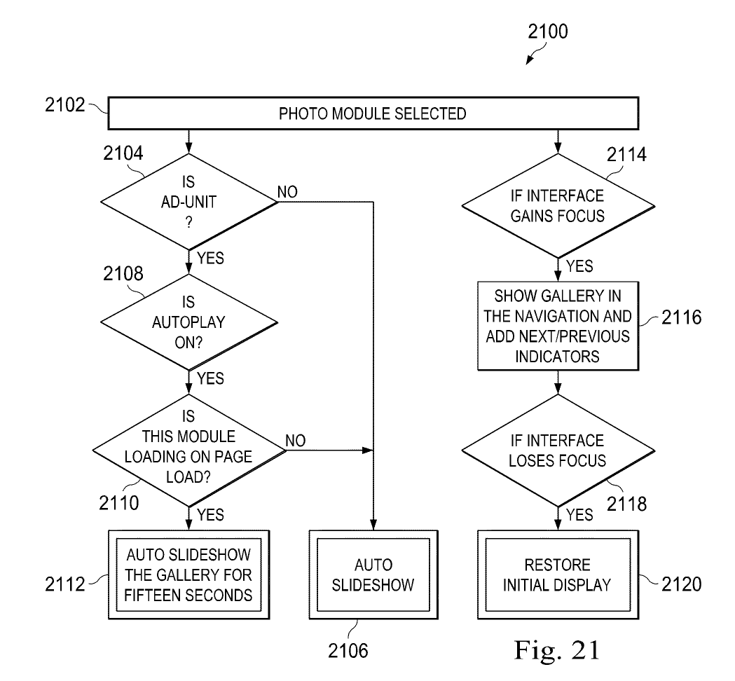

FIG. 18 illustrates another example report 1800. Similar to report 1300, report 1800 illustrates the parent-child relationships among various rich media interface instances. The report 1800 has a rich media interface instance 1802 labeled “PICTELA” that is the original root instance from which all others were copied, either directly or indirectly. The descendant rich media interface instances spread out radially around the original instance 1802. The data used to create the report 1800 may be filtered to reduce the number of instances to be depicted, for example by requiring a certain number of impressions. The report 1800 may use color to indicate information about each rich media instance, for example, whether a payment was made to secure placement of the instance.

Other kinds of reports are also possible. Through the use of identifiers for each rich media interface instance and tokens for each user's computer, it is possible to collect data on the total number of user impressions, the number of unique user impressions based solely on token data, and the total number of unique user impressions across all rich media interface instances. A report may also include the number of impressions for a particular rich media interface instance and the mouse-over or overlay impressions per instance. The rich media interfaces may also report more detailed information, allowing the gathering of impression statistics on specific media assets, such as the number of clicks or amount of time spent on each asset.

The efficacy of the rich media interfaces may also be monitored by tracking users' activities after they view a rich media interface instance. Such tracking may be through tokens, such as third party tokens associated with an established online advertising network. For example, the user may subsequently purchase a product or service relevant to the rich media interface, and this sale may be credited in part to the rich media interface instance that the user viewed. The contribution report may also be used to determine how marketing funds should be spent in the future, or to decide on the remuneration due to a particular rich media interface distributor or host.

A report may also compare the statistics associated with two or more web sites that embed rich media interface instances with the same or similar content. For example, a report may compare the number of total or unique impressions that are received for a group of rich media interface instances.

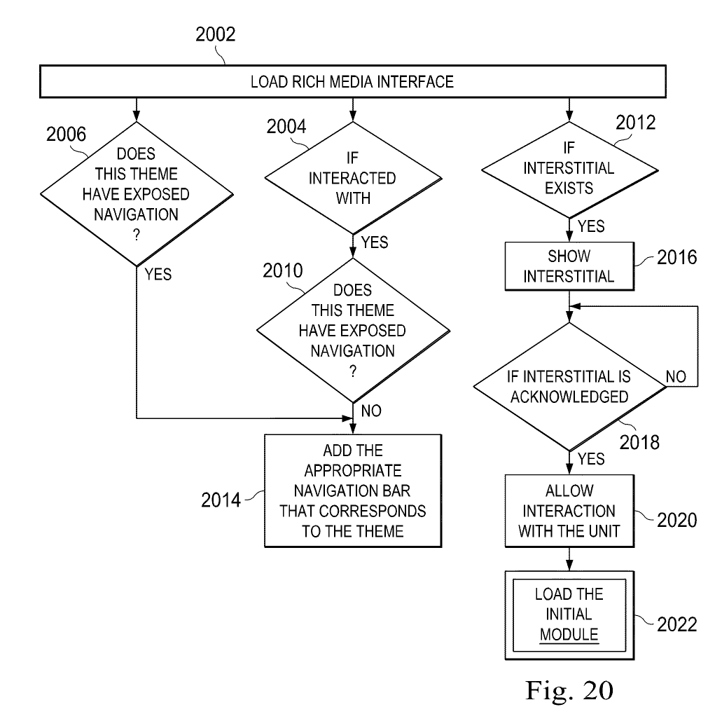

FIG. 16 illustrates a contribution report 1600. The contribution report 1600 displays various statistics by accumulating values for each rich media interface based on the reported statistics for that rich media interface and for all copies descended from that rich media interface. The reported values may be based on any measurement value that is tracked, for example total or unique impressions, roll-over rates, clicks, submits, engagement time, number of copies made, conversions, or any other suitable measurement value. Thus, the contribution report 1600 shows which rich media interface is responsible for creating, either directly or indirectly through sharing or copying, the most end-user interaction based on a selected measurement. This information may be used to help re-target an existing campaign or to plan a future campaign. For example, the data may show that a particular website is unexpectedly influential in marketing certain products or services because placement there led to many additional copies of the rich media interface being made either directly or indirectly or both. In the future, the owner or maintainer of that website may be targeted to receive information directly from a media asset provider about new products or services.

In other embodiments, a contribution report may be created using a filtered dataset. For example, a contribution report may be created using a date filter, thus including reported values from a subset of dates or times, for example only the past two weeks.

FIG. 17 illustrates another example contribution report 1700 that is limited to a certain depth of copying that is included in each rich media interface's report numbers. For each reported rich media interface, the contribution report 1700 shows the selected measurement values within three generations. Specifically, the values shown are the number of end-user impressions attributable directly to each rich media interface and to its children (that is, rich media interface copies made from it directly) and grandchildren. In other embodiments, the contribution report may show values attributed to more or fewer generations, for example, two generations: those values attributed directly to a rich media interface and its immediate children. The user may specify the number of generations to be summed up in creating the contribution report. The reported values may be based on any measurement value that is tracked, for example total or unique impressions, roll-over rates, clicks, submits, engagement time, number of copies made, conversions or any other suitable measurement value.

Comparing the data shown in FIGS. 16 and 17, it is apparent that although Site A is responsible for more total impressions when considering the contributions attributed to all of its descendants, Site C was responsible for more impressions when considering only the contributions of each rich media interface and its children and grandchildren.

A contribution report, such as those shown in FIGS. 16 and 17, may include or exclude from its display the original rich media interface that is the ancestor of all other rich media interfaces in a particular campaign or other group.

The contribution reports of FIGS. 16 and 17 are illustrated as graphs, but in other embodiments the data may be stored or presented in other ways, such as in a database, a table, or any other suitable form.

Any of the reports described may be scheduled so that the report is automatically generated on a requested frequency or at certain milestones. For example, a report may be generated when a certain number of instances have been created, such as 10 or 1000. These reports may be automatically emailed or otherwise delivered to a requester, such as a campaign organizer.

In addition, various kinds of reports may be combined. For example, a user viewing the report 1800 may indicate or select a particular rich media instance and receive a report showing that instance's contribution statistics over a selection of generations or over time or both.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. An apparatus comprising:
a tangible computer-readable medium storing a unique identifier that identifies a set of instructions that when executed by a computer cause the computer to:
display a media asset to a user;
report information on the user's interaction with the media asset to a data aggregation computer, wherein the information includes the unique identifier; and
respond to a user request by:
transforming an existing tangible computer-readable medium into a functionally equivalent copy of the apparatus that includes a different unique identifier.

2. The apparatus of claim 1 wherein the transforming comprises:
requesting the different unique identifier from the data aggregation computer, and
creating a web page that includes an instruction to incorporate the set of instructions.

3. The apparatus of claim 1 wherein the media asset is one of an image, a sound recording, a video recording, and a text.

4. The apparatus of claim 1 further comprising instructions that when executed by a computer cause the computer to:
receive information from a server and save the information in a token on the computer;
provide information from the token to the server.

5. The apparatus of claim 1 wherein the functionally equivalent copy of the apparatus uses a different execution environment.

6. The apparatus of claim 5 wherein the functionally equivalent copy is capable of executing on the computer without interacting with the server.

7. The apparatus of claim 1 further comprising instructions that when executed by a computer cause the computer to:
receive second information from a server;
store the second information in a file on a storage device accessible to the computer.

8. The apparatus of claim 7 wherein the second information is a document encoded in Portable Document Format (PDF).

9. The apparatus of claim 7 wherein the second information is an audio recording encoded in a compressed audio format.

10. A method of tracking the distribution of a multimedia branding campaign comprising:
creating a rich media interface object accessible through a first instance identified by a first identifier, the rich media interface object being adapted to self-replicate by causing the creation of a second identifier that identifies a second instance of the rich media interface object;
storing the rich media interface object on a first nonvolatile storage medium;
storing the first identifier on a second nonvolatile storage medium;
receiving information on self-replication activities of the rich media interface object;
generating a report illustrating the self-replication activities.

11. The method of claim 10 wherein the report comprises a visual depiction of a plurality of parent-child relationships among a plurality of instances of the rich media interface object.

12. The method of claim 11 wherein the visual depiction shows how the parent-child relationships arose over time.

13. The method of claim 10 wherein the report comprises the contribution of an instance of the rich media interface calculated by summing the instance's direct contribution and the contributions of a number of generations of child instances.

14. The method of claim 13 wherein the number of generations of child instances is one.

15. The method of claim 13 wherein the number of generations of child instances is two.

16. The method of claim 15 wherein the number of generations of child instances includes all descendant generations.

17. The method of claim 10 further comprising:
creating a branding campaign;
receiving media assets associated with the branding campaign;
receiving information on end-user interaction with the media assets;
and wherein the generating step comprises generating a summary of the information on end-user interaction with the media assets.

18. A method of promoting a brand through a self-replicating rich media interface comprising:
receiving a plurality of media assets, wherein at least some of the media assets are associated with a campaign to promote a brand of products, services or both;
storing information about the media assets in a database;
generating a first identifier having a value;
associating the first identifier with a first rich media interface adapted to access a set of media assets, the set of media assets comprising at least some of the media assets received in the receiving step;
writing the value of the first identifier to a nonvolatile storage medium;
providing a link to the first rich media interface, wherein the link to the first rich media interface comprises the first identifier;
receiving a request to access the first rich media interface, the request including the first identifier, and in response to the request causing a selected media asset in the plurality of media assets to be presented to a user;
receiving a request to create a second rich media interface adapted to access the set of media assets, the second rich media interface being a child of the first rich media interface, wherein the request further includes the first identifier associated with the first rich media interface;
generating a second identifier having a value different from the value of the first identifier;
associating the second identifier with the second rich media interface;
associating the second identifier with the first identifier;
providing a link to the second rich media interface, wherein the link to the second rich media interface comprises the second identifier.

19. The method of claim 18 further comprising:
associating an embedding location with the first identifier; and wherein the providing access step comprises:
comparing a referral location included in the request to access a rich media interface with the embedding location;
if the referral location matches the embedding location, providing access to the first rich media interface;
if the referral location does not match the embedding location, providing an alternate response that does not enable access to the first rich media interface.

20. The method of claim 19 wherein the alternate response is an error message.
